(19) United States
(12) Patent Application Publication
(10) Pub. No.: US 2010/0266799 A1
(43) Pub. Date: Oct. 21, 2010

(54) PREPOLYMERS AND POLYMERS FOR ELASTOMERS

(75) Inventors: William A. Koonce, Pearland, TX (US); Dwight D. Latham, Clute, TX (US); Randall C. Jenkines, Dalton, GA (US); Debkumar Bhattacharjee, Lake Jackson, TX (US); Zenon Lysenko, Midland, MI (US); Hongyu Chen, Zhanjiang (CN); Mark F. Sonnenschein, Midland, MI (US); Klaus Schiller, Halle (DE); Cora Leibig, Lake Jackson, TX (US); Alan K. Schrock, Lake Jackson, TX (US)

Correspondence Address: The Dow Chemical Company, P.O. BOX 1967, Midland, MI, 48641, US

(73) Assignee: Dow Global Technologies Inc., Midland, MI (US)

(21) Appl. No.: 12/668,500

(22) PCT Filed: Jul. 9, 2008
(86) PCT No.: PCT/US08/69487

§ 371 Date: Jul. 1, 2010

Related U.S. Application Data
(60) Provisional application No. 60/959,304, filed on Jul. 12, 2007.

(51) Int. Cl. C08G 18/10; C08G 18/34; B32B 1/08

(52) U.S. Cl. 428/36.9; 528/74.5; 560/330; 521/170

(57) ABSTRACT

A prepolymer or elastomer is the reaction product of reactants (a) at least one polyester polyol or fatty acid derived polyol which is the reaction product of at least one initiator and a mixture of fatty acids or derivatives of fatty acids comprising at least about 45 weight percent monounsaturated fatty acids or derivatives thereof, (b) optionally, at least one polyol which is different from the polyol of (a); and (c) at least one isocyanate compound (herein after isocyanate) having an average of at least about 1.8 isocyanate groups per molecule. A process comprises admixing reactants (a) at least one polyol composition comprising the fatty acid derived polyol which is the reaction product of at least one initiator and a mixture of fatty acids or derivatives of fatty acids comprising at least about any of 45 weight percent monounsaturated fatty acids or derivatives thereof; and (b) at least one isocyanate having an average functionality of at least about 1.8 under reaction conditions to form a reaction product which is an elastomer or prepolymer is formed therefrom. An article, coating or thermoplastic polyurethane comprises the elastomer is formed from the prepolymer of or using the process of the invention.

### CROSS-REFERENCE TO RELATED APPLICATIONS

This application claims benefit of U.S. Provisional Patent Application Ser. No. 60/959,304, filed Jul. 12, 2007, entitled “Prepolymers and polymers for elastomers” which is herein incorporated by reference.

### BACKGROUND

This invention involves polyols, prepolymers, especially prepolymers of isocyanates and the polyols, preferably prepolymers useful for making elastomers as well as polyurethanes made from the polyols, the prepolymers or combinations thereof.

Elastomeric polyurethanes are well known in the art for uses ranging from shoe soles and fibers to coatings and plastic parts. Such elastomeric polyurethanes are typically manufactured from such materials as polyether polyols derived from alkene oxides which are ultimately of petroleum origin. It would be desirable to manufacture elastomeric polyurethanes using renewable resources such as plant or animal derived materials. While polyols prepared from natural oils have been useful in some polyurethanes, particularly slabstock foams, these polyols have found little application in elastomeric polyurethanes. One reason has been that natural oil based polyols useful in foams have often been of lower molecular weight than polyether polyols that give similar foam properties and so low as to exhibit a Tg of the polymer nearer to a use temperature, that is near the range of −20 to 20° C. Use of polyols derived from natural oils with higher molecular weights has often resulted in insufficient elongation for optimum properties even in foams. It would be desirable to have a polyol derived from natural sources that would achieve sufficient elongation to produce a polyurethane elastomer, preferably greater than about 200 percent. The polyol would preferably have a Tg of less than about −20° C.

### SUMMARY OF THE INVENTION

It has now been found that using at least one polyester polyol or fatty acid derived polyol which is the reaction product of at least one initiator and a mixture of fatty acids or derivatives of fatty acids comprising at least about 45 weight percent monounsaturated fatty acids or derivatives thereof in making a polyurethane results in an elastomer, especially when the initiator has an average of from 1.7 to 4 reactive groups. In one preferred embodiment a prepolymer is formed and extended with a chain extender.

The invention includes a prepolymer or elastomer which is the reaction product of reactants (a) at least one polyester polyol or fatty acid derived polyol which is the reaction product of at least one initiator and a mixture of fatty acids or derivatives of fatty acids comprising at least about 45 weight percent monounsaturated fatty acids or derivatives thereof, (b) optionally, at least one polyol which is different from the polyol of (a); and (c) at least one isocyanate compound (herein after isocyanate) having an average of at least about 1.8 isocyanate groups per molecule.

In another aspect the invention is a process comprising admixing reactants (a) at least one polyol composition comprising the fatty acid derived polyol which is the reaction product of at least one initiator and a mixture of fatty acids or derivatives of fatty acids comprising at least about any of 45 weight percent monounsaturated fatty acids or derivatives thereof; and (b) at least one isocyanate having an average functionality of at least about 1.8 under reaction conditions to form a reaction product which is an elastomer or prepolymer is formed therefrom.

In another aspect of the invention is an elastomer which is the reaction product of reactants (a) at least one polyester polyol or fatty acid derived polyol which is the reaction product of at least one initiator and a mixture of fatty acids or derivatives of fatty acids comprising at least about 90 weight percent monounsaturated fatty acids or derivatives thereof, (b) optionally, at least one polyol which is different from the polyol of (a); (c) at least one isocyanate compound having an average of at least about 1.8 isocyanate groups per molecule; (d) at least one chain extender.

In another aspect, the invention is an article, coating, adhesive, binding, or thermoplastic polyurethane comprising the elastomer of the invention or formed from the prepolymer of or formed using the process of the invention.

### BRIEF DESCRIPTION OF THE DRAWINGS

FIG. 1 is a graph of storage modulus against temperature for two elastomers of the invention and 2 comparative samples.

FIG. 2 is a graph of tan delta against temperature for two elastomers of the invention and 2 comparative elastomers.

FIG. 3 is a plot of X-ray diffraction intensity against 2 multiplied by the light incidence angle for 2 polyurethane elastomers of the invention and 2 comparative elastomers.

FIG. 4 is a graph of tensile stress strain curves of the polyurethane elastomers Examples 4-9.

FIG. 5 is a graph of tan delta against temperature for the polyurethane elastomers Examples 4-9.

FIG. 6 is a graph of the storage modulus against temperature of the polyurethane elastomers Examples 4-9.

FIG. 7 is a graph of the second melting curves of the polyurethane elastomers Examples 4-9.

### DETAILED DESCRIPTION OF THE INVENTION

### Definitions

The term “elastomer” is used herein to refer to a polymer which exhibits tensile elongation at break of advantageously at least about 200, preferably at least about 220, more preferably at least about 240, most preferably at least about 260 and preferably at most about 2000, more preferably at most about 1700, and, in some embodiments, most preferably at most about 1500 percent as measured by the procedures of ASTM D-412 and/or D-882.

By the term “polyurethane” is meant a polymer whose structure contains predominately urethane linkages between repeating units. Such linkages are formed by the addition reaction between an organic isocyanate group R—[—NCO] and an organic hydroxyl group [HO—]—R. In order to form a polymer, the organic isocyanate and hydroxyl group-containing compounds must be at least difunctional. However, as modernly understood, the term “polyurethane” is not limited to those polymers containing only urethane linkages, but includes polymers containing minor amounts of allophanate, biuret, carbodiimide, oxazolinyl, isocyanurate, uretidinedione, urea, and other linkages in addition to urethane. The reactions of isocyanates which lead to these types of linkages are summarized in the POLYURETHANE HANDBOOK, Gunter Vertel, Ed., Hanser Publishers, Munich,® 1985, in Chapter 2, p. 7-41; and in POLYURETHANES: CHEMISTRY AND TECHNOLOGY, J. H. Saunders and K. C. Frisch, Interscience Publishers, New York, 1963, Chapter III, pp. 63-118.

The term “prepolymer” is used to designate a reaction product of monomers which has remaining reactive functional groups to react with additional monomers to form a polymer.

The term “soft segments” as used herein refers to that portion of a polyurethane that comes from polyols having a molecular weight of at least about 500. These segments are observed to enable deformation, while maintaining cohesion of the polymer and increasing ultimate elongation. The amount of soft segments is estimated by calculation of ratio of weight of polyols having a molecular weight of at least 500 to total polymer weight. The true soft phase is often lower than this ratio due to phase mixing that may occur with hard phase. This phase mixing is more favored at lower polyol molecular weight and higher polyol functionalities.

The term “hard segments” as used herein refers to that portion of a polyurethane formed between the chain extender and the di- or poly-isocyanate. The hard segment is observed to provide resistance to deformation, increasing polymer modulus and ultimate strength. An amount of hard segments is estimated by calculation of ratio of weight of di- or poly-isocyante and chain extender to total polymer weight.

The term “elongation” as applied to a polymer not in the form of a foam is used herein to refer to the percentage that the material specified can stretch (extension) without breaking and is tested in accordance with the procedures of ASTM D412 unless stated otherwise when similar methods such as the procedures of ASTM D-1708 are used.

The term “ultimate elongation” as applied to a polymer is used herein to refer to the linear extension which a sample of foam can attain before rupture. The foam is tested by the same method used to determine tensile strength, and the result is expressed as a percentage of the original length of the foam sample according to the procedures of ASTM D-3574, Test E.

The term “modulus of elasticity” or “elasticity modulus” is a measure of material stiffness. It is the proportionality factor that relates the change in unit length of a material in response to a unit stress within the linear elastic limits, and is a characteristic of the material. The modulus of elasticity is obtained by dividing the applied force by the cross sectional area of the material normal to the applied force, to obtain the applied stress; this stress is then divided by the resulting strain to obtain modulus. Modulus of elasticity is measured according to the procedures of ASTM D-412 unless stated otherwise.

The term “storage modulus” is used to designate the energy stored by material under cyclic deformation. It is that portion of the stress strain response which is in phase with the applied stress. The storage modulus is related to that portion of the polymer structure that fully recovers when an applied stress is removed. The storage modulus is determined using dynamic mechanical analysis (DMA) tests. These measurements are made using a commercially available DMA instrument such as that available from TA Instruments under the trade designation RSA III, using a rectangular geometry in tension. Specimens are ramped from an initial temperature of −90 PC to a final temperature of 250° C. at 2° C./minute.

The term “tan delta” is used to designate the tangent of the phase angle between an applied stress and strain response in dynamic mechanical analysis. High tan delta values imply that there is a high viscous component in the material behavior and hence a strong damping to any perturbation will be observed. The tan delta is determined using the same instrument and temperature change described for the storage modulus.

“Glass transition temperature” (Tg) is the temperature point corresponding to the peak value of the tan delta curve in a dynamic mechanical analysis (DMA) measurement. The temperature corresponding to the peak of the tan delta curve is taken as the glass transition temperature (Tg) of the specimen tested.

The term “density” is used herein to refer to weight per unit volume of a foam. Density is determined according to the procedures of ASTM D357401, Test A.

The term “resilience” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height. As measured according to the ASTM test.

The term “NCO Index” means isocyanate index, as that term is commonly used in the polyurethane art. As used herein as the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

As used herein, “polyol” refers to an organic molecule having an average of greater than 1.0 hydroxyl groups per molecule. It may also include other functionalities, that is, other types of functional groups.

As used herein the term “conventional polyether polyol” is a polyol formed from at least one alkylene oxide, preferably ethylene oxide, propylene oxide or a combination thereof, and not having a part of the molecule derived from a vegetable or animal oil, a polyol of the type commonly used in making polyurethanes. A polyether polyol can be prepared by known methods such as by alkoxylation of suitable starting molecules. Such a method generally involves reacting an initiator such as, water, ethylene glycol, or propylene glycol, with an alkylene oxide in the presence of a catalyst. Ethylene oxide, propylene oxide, butylene oxide, or a combination of these oxides can be particularly useful for the alkoxylation reaction. A polyether polyol, for instance polyoxyethylene polyol can contain alkyl substituents. The process for producing polyether polyols can involve a heterogeneous feed of a mixture of alkylene oxides, a sequential feed of pure or nearly pure alkylene oxide polyols to produce a polyol with blocks of single components, or a polyol which is capped with, for example, ethylene oxide or propylene oxide. These types of polyols are all known and used in polyurethane chemistry.

The term “natural oil polyol” (hereinafter NOP) is used herein to refer to compounds having hydroxyl groups which compounds are isolated from, derived from or manufactured from natural oils, including animal and vegetable oils, preferably vegetable oils. Examples of vegetable and animal oils that may be used include, but are not limited to, soybean oil, safflower oil, linseed oil, corn oil, sunflower oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl content. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil). Natural oil polyols are well within the knowledge of those skilled in the art, for instance as disclosed in Colvin et al., UTECH Asia, Low Cost Polyols from Natural Oils, Paper 36, 1995 and “Renewable raw materials—an important basis for urethane chemistry:” Urethane Technology: vol. 14, No. 2, Apr./May 1997, Crain Communications 1997, WO 01/04225, WO 040/96882; WO 040/96883; U.S. Pat. No. 6,686,435, U.S. Pat. No. 6,433,121, U.S. Pat. No. 4,508,853, U.S. Pat. No. 6,107,403, US Pregrant publications 20060041157, and 20040242910.

The term “fatty acid derived polyol” is used herein to refer to NOP compounds which are derived from fatty acids available from natural oils. For instance, fatty acids are reacted with compounds ranging from air or oxygen to organic compounds including amines and alcohols. Frequently, unsaturation in the fatty acid is converted to hydroxyl groups or to a group which can subsequently be reacted with a compound that has hydroxyl groups such that a polyol is obtained. Such reactions are discussed in the references in the preceding paragraph.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number may thus be defined as the weight of KOH in milligrams that will neutralize the acetic anhydride capable of combining by acetylation with 1 gram of a polyol. A higher hydroxyl number indicates a higher concentration of hydroxyl moieties within a composition. A description of how to determine the hydroxyl number for a composition can be found in texts well-known in the art, for example in Woods, G., The ICI Polyurethanes Book—2nd ed. (ICI Polyurethanes, Netherlands, 1990).

The term “primary hydroxyl group” means a hydroxyl group (—OH) on a carbon atom which has only one other carbon atom attached to it, (preferably which has only hydrogen atoms attached thereto) (—CH₂—OH).

The term “cure” or “cured” as applied to a polyurethane elastomer refers to the condition in which all isocyanate functional groups have been converted to other chemical species via chemical reactions.

The term “functionality” particularly “polyol functionality” is used herein to refer to the average number of hydroxyl groups on a polyol molecule.

In a preferred embodiment, polyols of the present invention are produced by the transesterification of vegetable oil based monomers (VOB's) as described in WO2004/096882 with a hydroxyl or polyhydroxyl functional species. As described therein, these VOB's are characterized by a structure containing from 0 to 3 primary OH species on a fatty acid moiety. The functionality distribution of these VOB's can be controlled and varied based on the starting composition of the fatty acids or by separation of VOB's themselves or their precursors.

It has surprisingly been found that polyols made from VOB mixtures containing higher percentages of mono-hydroxy VOB's than those made from soybean oil are useful in making elastomeric polyurethanes having improved properties as compared with polyurethanes made from polyols prepared from fatty acid mixtures commonly found in soybean oil. VOB's derived from soybean oil though generally considered high in monounsaturated fatty acids, commonly have less than 25 weight percent monounsaturated fatty acids combined with over 50 weight percent of fatty acids having 2 or more double bonds per molecule and 10 weight percent or more saturated fatty acids. The resulting VOB's if converted to an average hydroxyl functionality of 10H per molecule, yield a VOB with <40 percent mono-hydroxy VOB.

In one embodiment, this invention comprises prepolymer made from at least one fatty acid derived polyol and at least one isocyanate. The fatty acid derived polyol is suitably any such compound that those skilled in the art can use according to the practice of the invention to produce a prepolymer suitable for use in forming an elastomeric polyurethane. The fatty acid derived polyol advantageously has an average number of functional groups reactive with aromatic isocyanate groups, preferably hydroxyl groups per molecule of at least about 1.7, preferably at least about 1.8, more preferably at least about 1.9, most preferably at least about 1.95, and preferably at most about 3.5, more preferably at most about 3, and in one embodiment most preferably at most about 2. Thus, in this embodiment, the fatty acid derived polyol advantageously has at least about 45, preferably at least about 65, more preferably at least about 80, most preferably at least about 85 and up to 100 percent by weight molecules having 2 groups reactive with aromatic isocyanate groups, preferably hydroxyl groups. The embodiment most preferably having about 2 groups reactive with isocyanate groups often results in elastic properties where crosslinking is not desired; however, in alternative embodiments such as frothed foam, especially for such applications as carpet backing, foam gaskets, foam inserts for footware, and walk-off mats, a functionality of about 3 is most preferred to result in desired compression set properties.

This relatively low number of hydroxyl groups per fatty acid derived polyol molecule is suitably achieved by any means within the skill in the art. In one preferred embodiment, the fatty acid derived polyols are prepared from fatty acids or derivatives thereof (hereinafter fatty acid starting material) having one carboxylic acid group or derivative thereof and one functional group different from the carboxylic group and convertible to a group reactive with an aromatic isocyanate group, that is, preferably having one double bond (monounsaturated fatty acids). Most natural oils are made up of fatty acids having from zero to several double bonds. For instance, a natural soy oil typically contains 10 to 20 weight percent saturated fatty acids, 20 to 30 weight percent monounsaturated fatty acids, and 55 to 65 weight percent polyunsaturated fatty acids. Therefore, the fatty acid starting material is preferably selected from natural oils having high or enriched levels of monounsaturated fatty acids such as sunflower oil from seed commercially available from Dow AgroSciences LLC, a wholly owned subsidiary of The Dow Chemical Company, under the trade name NATREON™; from monounsaturated fatty acids purified or enriched in monounsaturation by means within the skill in the art such as distillation, extraction or other means such as that disclosed in copending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, which is incorporated by reference herein to the extent permitted by law, or from monounsaturated fatty acids produced from fatty acids having more than one or no unsaturation by means within the skill in the art such as hydrogenation. Alternatively, the polyol is prepared from reactions of purified chemicals, for instance the reaction of oleic acid with carbon monoxide via hydroformylation and subsequent hydrogenation to produce hydroxymethyl methylstearate. Thus, the fatty acids or derivatives advantageously are at least about 45, preferably at least about 65, more preferably at least about 80, most preferably at least about 85 and up to 100 percent by weight monounsaturated.

Polyols of the invention are suitably made by any process within the skill in the art that (a) converts an unsaturated fatty acid or derivative to a molecule which can be esterified or transesterified to form a polyester. Preferably a monounsaturated, monocarboxylic fatty acid or fatty acid derivative is converted to a compound having one carboxylic acid group or reactive derivative thereof such as an ester or anhydride (hereinafter carboxylic group) and one group reactive with the carboxylic group. More preferably, the double bond of the unsaturation is converted to a hydroxyl group or derivative thereof. A polyester is formed of the resulting functional acid derivative.

For instance the process disclosed in WO 04/096882 and WO 04/096883 is suitably used except that the starting material has a preferred amount of monounsaturated fatty acids. Initiators having active hydrogen such as a polyol or polyamine, amino alcohol or mixture thereof are reacted with a monomer prepared by such processes as hydroformylation of monounsaturated fatty acids or esters, followed by hydrogenation of at least a portion of the resulting formyl groups. Such a polyol is also referred to hereinafter as “initiated fatty acid polyester alcohol.”

In making a initiated fatty acid polyester alcohol preferred in the practice of the invention, a hydroxymethyl-containing polyester polyol is conveniently prepared by reacting a fatty acid having one hydroxymethyl-group and having from 12-26 carbon atoms, or an ester of such a hydroxymethylated fatty acid, with an initiator which is preferably a polyol, hydroxylamine or polyamine initiator compound advantageously having an average of at least about 1.7, preferably at least about 1.9, more preferably at least about 1.95, most preferably at least about 2.0, and preferably at most about 4.0, more preferably at most about 3.5, most preferably at most about 3.0 hydroxyl, primary amine and/or secondary amine groups/molecule. Proportions of starting materials and reaction conditions are selected such that the resulting hydroxymethyl-containing polyester polyol contains an average of at least about 1, preferably at least about 2, more preferably at least about 2.5, most preferably at least about 3, and preferably at most about 16, more preferably at most about 13, most preferably at most about 7 repeating units derived from the hydroxymethyl-group containing fatty acid or ester thereof for each hydroxyl, primary amine and secondary amine groups in the initiator compound. The resulting hydroxymethyl-containing polyester polyol has an molecular weight of at least about 1000 preferably at least about 1500, more preferably at least about 1750, most preferably at least about 2000, and preferably at most about 10000, more preferably at most about 8000, most preferably at most about 4000 for an equivalent weight of preferably at least about 500, more preferably at least about 750, most preferably at least about 1000, and preferably at most about 5000, more preferably at most about 4000, most preferably at most about 2000. The initiator reactive species on the initiator (for instance hydroxyl or amine group or groups) should be at least as reactive toward the methyl ester as the hydroxyl on the monomer itself. Thus, its reactivity should be at least that of a primary hydroxyl group.

The resulting hydroxymethyl-containing polyester polyol advantageously is a mixture of compounds having the following average structure (Structure 1):

[H—X]₍ₙ₋ₚ₎—R—[X—Z]ₚ (Structure 1)

wherein R is the residue of an initiator compound having n hydroxyl and/or primary or secondary amine groups, where n is at least two; each X is independently —O—, —NH— or —NR′— in which R′ is an inertly substituted alkyl, aryl, cycloalkyl, or aralkyl group, p is a number from 1 to preferably about 16 representing the average number of [X—Z] groups per hydroxymethyl-containing polyester polyol molecule, Z is a linear or branched chain comprising residues of fatty acids. “Inertly substituted” groups are groups that do not react with an isocyanate groups and which do not otherwise engage in side reactions during the preparation of the hydroxymethyl-group containing polyester polyol. Examples of such inert substituents include as aryl, cycloalkyl, silyl, halogen (especially fluorine, chlorine or bromine), nitro, ether, ester, and the like.

In formula I, n is preferably 2-8, more preferably 2-6, even more preferably 2-5 and especially about 3-5. Each X is preferably —O—. The total average number of fatty acid residues per hydroxymethylated polyol molecule is preferably at least 1.5 times the value of n, such from 1.5 to 10 times the value of n, about 2 to 10 times the value of n or from 2 to 5 times the value of n.

Most preferably, the polyol of the invention has a formula corresponding to Structure 1 wherein, Z corresponds to the following Structure 2:

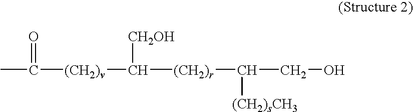

where v, r and s are integers and v is greater than 3, r is greater than or equal to zero, s is greater than or equal to zero, and v+r+s is from 10 to 18.

Hydroxymethyl-containing polyester polyols according to structure 1 can be prepared in a multi-step process from vegetable or animal fats that contain one or more carbon-carbon double bonds in at least one constituent fatty acid chain. Suitable fats include, for example, chicken fat, canola oil, citrus seed oil, cocoa butter, corn oil, cottonseed oil, lard, linseed oil, oat oil, olive oil, palm oil, peanut oil, rapeseed oil, rice bran oil, safflower oil, sesame oil, soybean oil, sunflower oil, or beef tallow.

The vegetable or animal fat is conveniently first subjected to a transesterification reaction with a lower alkanol, especially methanol or ethanol, to produce alkyl esters of the constituent fatty acids. The resulting alkyl esters are optionally hydrolyzed to the corresponding fatty acids. The alkyl esters of fatty acids are optionally purified to produce the desired levels of monounsaturated acid derivatives. The alkyl esters (or fatty acids) are conveniently hydroformylated by reaction with carbon monoxide and hydrogen. This introduces —CHO groups onto the fatty acid chain at the site of carbon-carbon unsaturation. Especially, if reactants were not purified or enriched at earlier stages to achieve the desired levels of monounsaturated acid derivatives, the aldehydes are optionally purified to enrich mono-aldehyde constituents. Suitable hydroformylation methods are described in U.S. Pat. Nos. 4,731,486 and 4,633,021, for example, and in U.S. Publication 2006/0193806, filed Apr. 25, 2003, all incorporated herein by reference to the extent permitted by law. A subsequent hydrogenation step converts the —CHO groups to hydroxymethyl (—CH₂OH) groups while hydrogenating residual carbon-carbon bonds to remove essentially all carbon-carbon unsaturation. Especially, if reactants were not purified or enriched at earlier stages to achieve the desired levels of monounsaturated acid derivatives, the hydroxymethyl derivatives are optionally purified to increase monohydroxymethyl constituents. The resulting mixture of hydromethylated fatty acids is then reacted with an initiator compound, with removal of water or lower alkanol to form the polyester polyol.

The initiator contains two or more hydroxyl, primary amine or secondary amine groups, and can be a glycol, polyol, an alkanol amine or a polyamine. Initiators of particular interest are polyols or short chain aliphatic diols. Preferred diols include 1,6 hexane diol, 1,4-butane diol, 1,3-cyclohexanedimethanol, and 1,4-cyclohexanedimethanol while the preferred polyols include those initiated using alkoxylated, preferably polymers of ethylene oxide and/or propylene oxide, ethoxylated, polyhydroxyl compounds, preferably glycerin, sucrose, or combinations thereof, and having a molecular weight of advantageously at least about 60, more preferably at least about 80, most preferably at least about 100 and preferably at most about 2000, more preferably at most about 1000, most preferably at most about 800.

The hydroxymethyl-containing polyester polyol so produced generally contains some unreacted initiator compound, and may contain unreacted hydromethylated fatty acids (or esters). Initiator compounds often react only monofunctionally or difunctionally with the fatty acids (or esters), and resulting polyester polyol often contains free hydroxyl or amino groups bonded directly to the residue of the initiator compound.

The fatty acid derived polyol is optionally used in mixtures with polyols different from fatty acid derived polyols. For instance, it is optionally used with other polyols including polyethers, polyesters, polyacrylics, polycarbonates and the like and combinations thereof. Such polyols are within the skill in the art. When used in combination with other polyols, the fatty acid derived polyol which is preferably the reaction product of at least one initiator and a mixture of fatty acids or derivatives of fatty acids comprising at least about 45 weight percent monounsaturated fatty acids is present in an amount of preferably at least about 10, more preferably at least about 25, most preferably at least about 50 to at most about 100 weight percent based on total weight of polyols, and at least one other polyol which is not the reaction product of at least one initiator and a mixture of fatty acids or derivatives of fatty acids comprising at least about 45 weight percent monounsaturated fatty acids is present in an amount of from preferably at most about 90, more preferably at most about 75, most preferably at most about 50 weight percent.

The fatty acid derived polyol composition is reacted with at least one isocyanate having an average of 1.8 or more isocyanate groups per molecule. The isocyanate functionality is preferably at least about 1.8, more preferably at least about 2.0 and preferably at most about 4, at most about 3, most preferably at most about 2.7. Aromatic polyisocyanates are generally preferred based on properties imparted to the product polyurethane. Exemplary polyisocyanates include, for example, m-phenylene diisocyanate, 2,4- and/or 2,6-toluene diisocyanate (TDI), the various isomers of diphenylmethanediisocyanate (MDI), and polyisocyanates having more than 2 isocyanate groups, preferably MDI and derivatives of MDI such as biuret-modified “liquid” MDI products and polymeric MDI (PMDI), 1,3 and 1,4-(bis isocyanatomethyl)cyclohexane, isophorone diisocyanate (IPDI), hexamethylene diisocyanate (HDI), bis(4-isocyanatocyclohexyl)methane or 4,4′ dimethylene dicyclohexyl diisocyanate (H12MDI), and the like and combinations thereof, as well as mixtures of the 2,4- and 2,6-isomers of TDI, with the latter most preferred in the practice of the invention. A 65/35 weight percent mixture of the 2,4 isomer to the 2,6 TDI isomer is typically used, but the 80/20 weight percent mixture of the 2,4 isomer to the 2,6 TDI isomer is also useful in the practice of this invention and is preferred based on availability. Other preferred isocyanates include methylene diphenyl diisocyanate (MDI) and or its polymeric form (PMDI) for producing the foams of the invention.

Preferably, the elastomers are prepared by a prepolymer process, however, the one shot process is useful as well. In the prepolymer process, the polyol mixture is reacted with excess di- or polyisocyanate to form an isocyanate-terminated prepolymer containing an average of 2 or more isocyanate groups per molecule. The isocyanate is used in a stoichiometric excess (NCO:OH) of at least about 1.05:1, more preferably at least about 1.10:1, most preferably at least about 1.20:1, and preferably at most about 10:1, at most about 8:1, most preferably at most about 5:1, leaving a prepolymer having isocyanate functionality. The prepolymer has an equivalent weight of preferably at least about 100, more preferably at least about 300, and preferably at most about 30000, more preferably at most about 20000, most preferably at most about 10000 grams per isocyanate group (equivalent weight). Prepolymer preparation is optionally catalyzed, preferably by tin catalysts such as dibutyltin diacetate and dibutyltin dilaurate, in amounts of ppm based on weight of prepolymer preferably at least about 10, more preferably at least about 50 and preferably at most about 5000, at most about 2500, most preferably at most about 1000 by weight. The manufacture of prepolymers is within the level of skill in the art. If desired, the prepolymer polyol component is optionally augmented with hydroxyl-functional polyols other than polyoxyalkylene polyols, for example polyester polyols, polycaprolactone polyols, polytetramethylene ether glycols (PTMEG), polycarbonate polyols and the like.

Catalysts within the skill in the art are used to facilitate the reaction of fatty acid derived polyol and isocyanate. A wide variety of materials are known to catalyze polyurethane forming reactions, including tertiary amines; tertiary phosphines such as trialkylphosphines and dialkylbenzylphosphines; various metal chelates such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni; acid metal salts of strong acids, such as ferric chloride, stannic chloride, stannous chloride, antimony trichloride, bismuth nitrate and bismuth chloride; strong bases such as alkali and alkaline earth metal hydroxides, alkoxides and phenoxides, various metal alcoholates and phenolates such as Ti(OR)₄, Sn(OR)₄ and Al(OR)₃, wherein R is alkyl or aryl, the reaction products of the alcoholates with carboxylic acids, beta-diketones and 2-(N,N-dialkylamino)alcohols; alkaline earth metal, Bi, Pb, Sn or Al carboxylate salts; tetravalent tin compounds, tri- or pentavalent bismuth, antimony or arsenic compounds and combinations thereof. Preferred catalysts include tertiary amine catalysts and organotin catalysts. Examples of commercially available tertiary amine catalysts include: trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used. Examples of commercially available amine catalysts include Niax™ A1 and Niax™ A99 (bis(dimethylaminoethyl)ether in propylene glycol available from GE Advanced Materials, Silicones), Niax™ B9 (N,N-dimethylpiperazine and N-N-dimethylhexadecylamine in a polyalkylene oxide polyol, available from GE Advanced Materials, Silicones), Dabco™ 8264 (a mixture of bis(dimethylaminoethyl)ether, triethylenediamine and dimethylhydroxyethyl amine in dipropylene glycol, available from Air Products and Chemicals), and Dabco™ 33LV (triethylene diamine in dipropylene glycol, available from Air Products and Chemicals), Niax™ A-400 (a proprietary tertiary amine/carboxylic salt and bis(2-dimethylaminoethy)ether in water and a proprietary hydroxyl compound, available from GE Advanced Materials, Silicones); Niax™ A-300 (a proprietary tertiary amine/carboxylic salt and triethylenediamine in water, commercially available from GE Advanced Materials, Silicones); Polycat™ 58 (a proprietary amine catalyst available from Air Products and Chemicals), Polycat™ 5 (pentamethyl diethylene triamine, available from Air Products and Chemicals) and Polycat™ 8 (N,N-dimethyl cyclohexylamine, available from Air Products and Chemicals).

Examples of organotin catalysts are stannic chloride, stannous chloride, stannous octoate, stannous oleate, dimethyltin dilaurate, dibutyltin dilaurate, other organotin compounds of the formula SnRn(OR)4-n, wherein R is alkyl or aryl and n is 0-2, and the like. Organotin catalysts are generally used in conjunction with one or more tertiary amine catalysts, if used at all. Commercially available organotin catalysts of interest include Dabco™ T-9 and T-95 catalysts (both stannous octoate compositions available from Air Products and Chemicals).

Catalysts are typically used in small amounts, for example, each catalyst being employed from 10 ppm (parts by weight per million) to 1 weight percent by weight of the resulting polymer. The amount depends on the catalyst or mixture of catalysts, the desired balance of the isocyanate-hydroxyl reactions for specific equipment, the reactivity of the polyols and isocyanate as well as other factors familiar to those skilled in the art.

The prepolymer is conveniently reacted with at least one chain extender to produce hard segments in the resulting elastomeric polyurethane. A chain extender is a material having exactly two isocyanate-reactive groups/molecule. The equivalent weight per isocyanate-reactive group is preferably at least about 9 and preferably at most about 300, more preferably at most about 200. The isocyanate-reactive groups are preferably aliphatic alcohol, primary amine or secondary amine groups, with aliphatic alcohol groups being particularly preferred. Examples of chain extenders and crosslinkers include water, alkylene glycols such as ethylene glycol, 1,2- or 1,3-propylene glycol, 1,4-butanediol, 1,6-hexanediol, and the like; glycol ethers such as diethylene glycol, triethylene glycol, dipropylene glycol, tripropylene glycol and the like; cyclohexane dimethanol; glycerine; trimethylolpropane; triethanolamine; diethanol amine, aromatic diamines such as the toluenediamines and the alkylsubstituted (hindered) toluenediamines and the like, with diols, diamines and combinations thereof preferred. Water may also be considered a chain extender, as it will react with free isocyanate groups yielding the corresponding amine and releasing carbon dioxide. The resulting amine reacts with remaining isocyanate groups to form a urea bond and advance molecular weight. In one embodiment, the chain extender is 2′,2-dihydroxy isopropyl-N aniline. In an other embodiment, the chain extender is 2-ethyl-1,3-hexanediol. The prepolymer and chain extender are thoroughly mixed, degassed if necessary, and introduced into the proper mold or, if thermoplastic polyurethanes are desired, reaction extruded and granulated or deposited on a moving belt and subsequently granulated. In the case of a moisture curing mechanism, ambient moisture is allowed to diffuse into the prepolymer and react with isocyanate species resulting in chain extension and the release of carbon dioxide.

Preferred chain extenders are the aliphatic and cycloaliphatic glycols and oligomeric polyoxyalkylene diols. Examples of suitable aliphatic glycol chain extenders are ethylene glycol, diethylene glycol, 1,2- and 1,3-propanediol, 2-methyl-1,3-propanediol, 1,2- and 1,4-butane diol, neopentyl glycol, 1,6-hexanediol, 1,4-cyclohexanediol, 1,4-cyclohexanedimethanol, hydroquinone bis(2-hydroxyethyl)ether, and polyoxyalkylene diols such as polyoxyethylene diols, polyoxypropylene diols, heteric and block polyoxyethylene/polyoxypropylene diols, polytetramethylene ether glycols, and the like, with molecular weights up to 300 Da. Preferred are 1,6-hexanediol and 1,4-butanediol, the latter particularly preferred.

Diamine chain extenders, for example the amine-terminated polyoxyalkylene polyethers sold under the tradename Jeffamine™ commercially available from Huntsman, and particularly the slower reacting deactivated or sterically hindered aromatic diamines such as 3,5-diethyltoluenediamine and 4,4′-methylenebis (2-chloroaniline) (MOCA) are optionally used, but generally only in most minor amounts. The advantageous effects of the subject polyol blends with diamine chain extenders is more difficult to quantify, as these systems are especially formulated for exceptionally short demold. Mixtures of aliphatic or cycloaliphatic diol chain extenders with diamine chain extenders are optionally used. When any significant amount of diamine is used, high pressure reaction injection molding techniques are frequently used.

Chain extenders are preferably used to form hard segments with the isocyanate such that the hard segment content is calculated as the percentage of isocyanate and chain extender in the total of isocyanate, chain extender and polyols. Polyols components (both those derived from fatty acids and others are considered soft segment, especially when their molecular weights are greater than about 500. In polyurethane elastomers produced using conventional polyols, hard segment content is often 30-45 weight percent. In the practice of the invention, hard segment content is preferably at least about 10, more preferably at least about 15, most preferably at least about 20 and preferably at most about 60, more preferably at most about 55, most preferably at most about 50 weight percent.

In polyurethane elastomers, it is commonly recognized that for good physical characteristics in use, it is preferred to have a soft segment having a glass transition temperature (Tg) well below the expected use temperature and a hard segment having a softening point or a melt temperature (Tm) well above the expected use temperature. The soft segment of the polyurethane elastomer of this invention provides a glass transition temperature (Tg) well below use temperatures. The hard segment provided by the isocyanate and chain extender can be selected to provide a softening point or melt temperature (Tm) well above the expected use temperature. Such selection can be made on the basis of ordinary laboratory experimentation and skill in the art.

The chain extender, including combinations of chain extenders and optional crosslinkers, is used in an amount are advantageously chosen such that virtually complete reaction of prepolymer NCO groups is achieved when maximum polymer molecular weight is desired. Greater amounts of chain extenders over the stoichiometric amount may exert a plasticizing effect which may be desirable in some instances. Too little chain extender and/or crosslinker will produce a product containing residual NCO groups which may react with each other to form allophanate, uretdione, or isocyanurate linkages, or with moisture to form urea linkages. In any event, the polymer properties will change over time, which in most cases is undesirable. Preferably, chain extenders, and optionally crosslinkers, are used at an isocyanate index of from 95 to 105, preferably about 100. The reaction of chain extender with prepolymer is facilitated by catalysts within the skill in the art. Catalysts are not typically employed for amino functional chain extenders due to their higher reactivity, but they are optionally used when faster reaction is desirable.

Types of chain extenders and methods of using them vary with the intended elastomeric polyurethane. For instance, in making an elastomeric polyurethane for forming a molded object, as illustrated by forming a plaque, or in making a thermoplastic polyurethane (TPU) a short chain aliphatic diol is advantageous, whereas in making an elastomeric fiber, a short chain diamine, preferably ethylene diamine is advantageous. Foams advantageously employ water chain extension.

Advantageously, use of crosslinkers is minimized if thermoplastic elastomers are desired, for as the degree of crosslinking increases, the melt processability rapidly decreases. Most minor amounts of crosslinkers may improve hardness, tensile strength, modulus, and compression set, while generally diminishing elongation and tear strength. Suitable crosslinkers are polyhydroxyl functional compounds such as glycerine, trimethylolpropane and their oxyalkylated oligomers, N,N,N′,N′-tetrakis[2-hydroxyethyl or 2-hydroxypropyl]-ethylene diamine, the various oxyalkylated aliphatic and aromatic diamines, aminophenols, and the like, particularly triethanolamine and tripropanolamine. The foregoing list of crosslinkers is illustrative, and not limiting. Preferably, the polyurethane elastomers of the subject invention are substantially or completely devoid of crosslinkers.

In most instances the polyurethane elastomers are cast, molded, spun or the like or combinations thereof. For these applications, blowing agents are not generally used. However, the polyurethane elastomers are also useful in microcellular products such as shoe soles and in foams, such as for furnishings, carpet backing, and seating. In these applications, blowing agents within the skill in the art are used.

Although it is preferred that no additional blowing agent (other than the water) be included in the foamable polyurethane composition, that is less than an intentional amount or preferably less than about 0.5 pphp, it is within the scope of the invention to include an additional physical or chemical blowing agent. Among the physical blowing agents are CO₂ and various hydrocarbons, fluorocarbons, hydrofluorocarbons, chlorocarbons (such as methylene chloride), chlorofluorocarbons and hydrochlorofluorocarbons, ketones such as methyl; ethyl ketone or acetone, and esters such as methyl formate and the like. Chemical blowing agents are materials that decompose or react (other than with isocyanate groups) at elevated temperatures to produce carbon dioxide and/or nitrogen.

Elastomeric polyurethanes of the invention optionally include any of the additives known in the art for the production of polyurethane polymers. Any of a range of additives such as antioxidants, UV stabilizers, plasticizers, emulsifiers, thickeners, flame retardants, surfactants, cell openers, colorants, fillers, load bearing enhancement additives such as copolymer polyols, internal mold releases, antistatic agents, antimicrobial agents, additives for reducing combustibility, dispersants, and other additives known to those skilled in the art are useful within the scope of the invention.

In forming the polyurethane from fatty acid derived polyol compositions, the fatty acid derived polyol composition is optionally blended with appropriate additives such as foaming agent, drying agent, filler, pigment, catalyst, and the like, to produce the formulated polyol. An amount of isocyanate previously discussed is added and stirred with the polyol. Optionally, the additives can be added to the isocyanate or following the synthesis of the prepolymer, for instance to the prepolymer, the chain extender or a combination thereof. In the case of a foam, the polyol/isocyanate mixture is advantageously maintained under vacuum until foaming stops and then poured into mold. A resulting polyurethane can be cured either at room temperature or at higher temperature.

The polymers of this invention are optionally cured by procedures conventional in the art for the curing of isocyanate terminated polymers. By way of example, but not limited to these procedures are use of moisture, blocked amines, oxazolidines, epoxies, triisocyanurate ring formation, allophonate and biruet crosslinking and the like. Dependent upon the curing technology employed, the resulting polyurethane elastomers may be either a thermoset polyurethane, or a higher melt temperature thermoplastic polyurethane once curing is accomplished.

Polyurethane elastomers of this invention are suitably made by batch or continuous processes. The mixing of the reactants is optionally accomplished by any of the procedures and apparatus within the skill in the art. Preferably, the individual components are urethane grade and, as such, have low moisture content or are rendered substantially free from the presence of water using conventional procedures, for example, by azeotropic distillation, or by heating under reduced pressure at a temperature in excess of the boiling point of water at the pressure employed. The later procedure is preferred to accomplish degassing of the components.

Analysis by dynamic mechanical analysis (DMA) is useful in characterizing elastomers of the invention. DMA is interpreted as showing the storage modulus of an elastomer is high at low temperatures when the temperature is below the soft segment glass transition temperature Tg. As the elastomer temperature passes Tg, its rigid, glassy nature undergoes a transition to the rubbery state and the storage modulus decreases rapidly, until a relatively flat plateau is reached. Elastomeric behavior is obtained in the region of the plateau, until the temperature reaches the melt temperature or softening temperature (Tm) of the hard segments. At this point, the elastomer begins to soften and flow. Extension of the lower range by lowering Tg results in an elastomer useable at lower temperature. Elastomers of the invention advantageously have lower Tg than elastomers produced by the same process using the same materials except that the polyol is formed from a fatty acid mixture having less than about 45 weight percent monounsaturated fatty acids or derivatives thereof. The slope of the plateau corresponds to how well a particular elastomer retains its physical properties with increasing temperature. In general, it is desired that an elastomer have the same degree of flexibility at low temperatures and high temperatures within its use range. This is illustrated by a slope of 0 degrees.

Another important property is the loss modulus, which is a measure of the energy loss of the elastomer due to the flow character or component. The ratio of loss modulus to storage modulus is the loss tangent delta (Tan Delta) which is related to the elastomer's dynamic performance. The lower the loss tangent delta, the lower the heat buildup of the elastomer under dynamic stress. This property is particularly important in applications where the elastomer is continually flexed or compressed, for example in jounce bumpers of front wheel drive vehicles. Advantageously, elastomers of the invention have a tan delta with a steeper slope and with a peak at a lower temperature than elastomers produced by the same process using the same materials except that the polyol is formed from a fatty acid mixture having less than about 45 weight percent monounsaturated fatty acids or derivatives thereof.

There may be unlimited ways of combining the various vegetable oil based monomers with the various initiators, isocyanates, and chain extenders. However, because polyols derived from these vegetable based polyols are typically hydrophobic or non-polar, The prepolymer made from them display low compatibility with typical hydrophilic or polar chain extenders, such as butane diol. It has been found that in certain embodiments, improved polyurethane elastomers may be obtained by improving the compatibility of the prepolymer made from vegetable oil based monomers with the chain extenders.

If the initiator used is a hydrophobic or non polar initiator, then the polyol may be made so that is has a low equivalent molecular weight, such as less than about 1000, preferably less than about 750, such as between about 500 and about 600. Such polyols may be more hydrophilic than polyols with higher equivalent molecular weights. In one embodiment, the initiator is 1,4-cyclohexanedimethanol. In another embodiment, the initiator is a 1:1 ratio of (cis, trans)-1,3-cyclohexanedimethanol and (cis, trans)-1,4-cyclohexanedimethanol.

If the initiator used is hydrophilic or polar, such as polyethylene oxide, the weight average molecular weight of the initiator may be at least 400, if the final polyol has a equivalent molecular weight of between about 900 and 1100. In one embodiment, the final polyol has an equivalent molecular weight of about 1000.

If the initiator used is a hydrophobic or non polar initiator and the resulting polyol has an equivalent molecular weight of about at least 900, a hydrophobic plyol compatible chain extender may be used, such as is 2′,2-dihydroxy isopropyl-N aniline (DIPA) or 2-ethyl-1,3,-hexanediol (EDH), to obtain elastomers with high toughness.

The elastomers of the invention are useful in ways within the skill in the art. For instance, pellets of a polyurethane elastomer are optionally prepared. Then, the pellets are melted and subjected to injection molding, extrusion molding or calendering to form a shaped article, such as an elastomer film or sheet, a hose, a tube, rolls or a gear. Alternatively, a prepolymer having isocyanate terminals is formed. The prepolymer, which cures by reaction with atmospheric moisture or additional reaction with a chain extender, can be used as an adhesive and a sealant. If the prepolymer is reactive with a polyisocyanate in the presence of a diol or diamine chain extender and, hence, it can be used as an adhesive, a sealant, a binder, a potting or casting material and a coating material. In another alternative a polyurethane solution is obtained by dissolving polyurethane material or polyurethane-forming materials in a solvent and used as a coating material for a synthetic leather, an artificial leather, fibers and a nonwoven fabric. Alternatively, a dispersion is obtained by dispersing a magnetic powder or an electrically conductive powder in such a polyurethane solution is used as a coating material for a magnetic tape or as an electromagnetic sealing material. Further, a dispersion obtained by dispersing a pigment or a staining agent in such a polyurethane solution is used as an ink, preferably for printing such as gravure printing or for coating. In another embodiment, a foam is formed, for instance by using additives, such as a foaming agent, a catalyst, a foam stabilizer and a fire retardant blended with the polyol of the present invention, and an organic polyisocyanate or a polyurethane prepolymer having isocyanate terminals is added thereto. The resultant mixture is stirred at high speed to obtain a thermosetting urethane foam product. In yet another embodiment, a polyurethane prepolymer having unreacted isocyanate groups is dissolved in a solvent. A chain extender is added to prepare a spinning solution. The spinning solution is subjected to dry, wet or melt spinning to obtain an elastic fiber.

The polyurethane elastomers are useful for elastomer applications such as forming rigid, semirigid and flexible articles. Such articles include, for example, an open-cell foam (such as a cushioning material), a closed-cell foam (such as a micro-cellular insole), a film, a sheet, a tube, a hose, a vibration-absorbing material, a packing, an adhesive, a binder, a sealant, a water resistant material, a flooring, a potting or casting material, a coating material, an adhesive, an elastic fiber, a composite with fibers and non-wovens and the like and combinations thereof. The elastomers are useful in diverse applications requiring castable, sprayable, or injectable elastomers such as: abrasion resistant coatings; coatings on metal or fabric for belting; flexible mechanical couplings, gears and drive wheels; mallet and hammer heads; rollers for printing and feed conveying; shock absorbent pads and bumpers; carpet backing, solid industrial truck tires and caster wheels and the like and combinations thereof. Elastomers of the invention are suitable for microcellular elastomers, for example those suitable for use in shoe soles. The formulations of such elastomers advantageously contain a minor amount of reactive or volatile blowing agent, preferably the former. For example, a typical formulation contains preferably at least about 0.1, more preferably at least about 0.2 and preferably at most about 1.0, more preferably at most about 0.4 weight percent water. Isocyanate terminated prepolymers are generally utilized in such formulations, and have higher NCO content, in general, than the prepolymers used to form non-cellular elastomers. Isocyanate group contents of preferably at least about 8, more preferably at least about 10, most preferably at least about 13 and preferably at most about 25, more preferably at most about 22, most preferably at most about 15 weight percent. The formulations are advantageously crosslinked and diol extended, the crosslinking being provided by employing, in addition to the glycol chain extender, a tri- or higher functional, low unsaturation polyol in the polyol composition, optionally also with a low molecular weight cross-linker such as diethanolamine (DEOA). Alternatively, the isocyanate-terminated prepolymer is optionally prepared from a tri- or higher functional polyol or a mixture of di- and higher functional low unsaturation polyols.

A preferred TPU is a polymer prepared from a mixture comprising at least one organic diisocyanate, at least one polymeric diol and at least one difunctional extender. The TPU is optionally prepared by the prepolymer, quasi-prepolymer, or one-shot methods in accordance with the methods described in Polyurethanes: Chemistry and Technology, Part II, Saunders and Frisch, 1964, pp 767 to 769, Interscience Publishers, New York, N.Y. and Polyurethane Handbook, Edited by G. Oertel 1985, pp 405 to 417, Hanser Publications, distributed in U.S.A. by Macmillan Publishing Co., Inc., New York, N.Y; for particular teaching on various TPU materials and their preparation see U.S. Pat. Nos. 2,929,800; 2,948,691; 3,493,634; 3,620,905; 3,642,964; 3,963,679; 4,131,604; 4,169,196; Re 31,671; 4,245,081; 4,371,684; 4,379,904; 4,447,590; 4,523,005; 4,621,113; 4,631,329; and 4,883,837 all of which illustrate the skill in the art and are incorporated to the fullest extent permitted by law.

Polyurethanes of the invention advantageously have properties at least comparable to polyurethane elastomers of the same type (that is comparing TPU with TPU, microcellular with microcellular, slab foam with slab foam, elastomer plaques with elastomer plaques of the same isocyanate and hard segment content wherein polyalkylene polyols are used in place of the fatty acid derived polyols of similar molecular weight (within 10, preferably 5, percent of the higher of two polyols to be compared) and the same average functionality. Among these properties, polyurethanes of the invention advantageously have at least one, preferably at least two, more advantageously at least 3, most advantageously at least 4, preferably 5, of the following properties:

(a) a tensile strength measured in accordance with ASTM D412 of at least about 1400 kPa preferably at least about 3000 kPa, more preferably at least about 4000 kPa, most preferably at least about 7000 kPa;
(b) an elongation measured in accordance with ASTM D412 of at least about 100 percent percent preferably at least about 150 percent, more preferably at least about 200 percent, most preferably at least about 250 percent;
(c) a Tg as determined by tan delta peak via dynamic mechanical analysis (DMA) tests using an instrument comparable to the instrument commercially available from TA Instruments under the trade designation RSA III using a rectangular geometry in tension according to manufacturer's directions and ramped from an initial temperature of −90 PC to a final temperature of 250 PC at 2 PC/minute of preferably at most about −20, more preferably at most about −30, most preferably at most about −35° C.;
(d) if thermoplastic, a Tm of at least about 80 preferably at least about 90, more preferably at least about 95, most preferably at least about 100° C.; or
(e) a toughness defined as the total energy required to break the polymer specimen measured via integration of the stress versus strain curve in accordance with ASTM D412 of at least about 700 kPa preferably at least about 2000 kPa, more preferably at least about 5000 kPa, most preferably at least about 10000 kPa.

Objects and advantages of this invention are further illustrated by the following examples. The particular materials and amounts thereof, as well as other conditions and details, recited in these examples should not be used to limit this invention. Unless stated otherwise all percentages, parts and ratios are by weight. Examples of the invention are numbered while comparative samples, which are not examples of the invention, are designated alphabetically.

### EXAMPLES

The following materials are used in making foams of the invention:

NOPO-A is a 2.0-functional natural oil polyol prepared using VOB monomers with an average of 1.0 hydroxyls per fatty acid derived from soy oil in its natural abundance yielding a distribution of about 27 percent weight percent saturated VOB monomer, about 40 percent weight percent mono-hydroxy VOB monomer, and about 33 percent weight percent di-hydroxyl VOB monomer. It is made by reacting these hydroxymethylated soybean fatty acid methyl esters with a 400 molecular weight, poly(ethylene oxide) glycol at a 3.8:1 molar ratio, using 650 ppm stannous octoate (commercially available from City Chemical Co.) as the catalyst. The resulting polyester has a viscosity of 1500 cP at 25° C., a hydroxyl equivalent weight of 744, Mn of 1488. NOPO-A has an average of approximately 2.0 hydroxyl groups/molecule. NOPO-A corresponds to Structure I, wherein X is —O—, and n=2.
NOPO-B is a 2.0-functional natural oil polyol prepared using VOB monomers with an average of 1.0 hydroxyls per fatty acid derived from soy oil in its natural abundance yielding a distribution of about 27 percent weight percent saturated VOB monomer, about 40 percent weight percent mono-hydroxy VOB monomer, and about 33 percent weight percent di-hydroxyl VOB monomer.
It is made by reacting these hydroxymethylated soybean fatty acid methyl esters with a 400 molecular weight, poly(ethylene oxide) glycol at a 7.4:1 molar ratio, using 720 ppm stannous octoate (commercially available from City Chemical Co.) as the catalyst. The resulting polyester has a viscosity of 3100 cP at 25° C., a hydroxyl equivalent weight of 1225, Mn of 2450. NOPO-B has an average of approximately 2.0 hydroxyl groups/molecule. NOPO-B corresponds to Structure I, wherein X is —O—, and n=2.
NOPO-C is a 2.0-functional natural oil polyol prepared using VOB monomers with an average of 1.0 hydroxyls per fatty acid derived from fractionated fatty acids yielding a distribution of about 4 percent weight percent saturated VOB monomer, about 92 percent weight percent mono-hydroxy VOB monomer, and about 4 percent weight percent di-hydroxyl VOB monomer. The monomer distribution is obtained using the method disclosed in copending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, which has been incorporated herein by reference.
It is made by reacting these hydroxymethylated soybean fatty acid methyl esters with a 400 molecular weight, poly(ethylene oxide) glycol at a 3.6:1 molar ratio, using 470 ppm stannous octoate (commercially available from City Chemical Co.) as the catalyst. The resulting polyester has a viscosity of 1300 cP at 25° C., a hydroxyl equivalent weight of 770, Mn of 1540. NOPO-C has an average of approximately 2.0 hydroxyl groups/molecule. NOPO-C corresponds to Structure I, wherein X is —O—, and n=2.
NOPO-D is a 2.0-functional natural oil polyol prepared using VOB monomers with an average of 1.0 hydroxyls per fatty acid derived from fractionated fatty acids yielding a distribution of about 4 percent weight percent saturated VOB monomer, about 92 percent weight percent mono-hydroxy VOB monomer, and about 4 percent weight percent di-hydroxyl VOB monomer. It is made by reacting these hydroxymethylated soybean fatty acid methyl esters with a 400 molecular weight, poly(ethylene oxide) glycol at a 6.8:1 molar ratio, using 550 ppm stannous octoate (commercially available from City Chemical Co.) as the catalyst. The resulting polyester has a hydroxyl equivalent weight of 1331, Mn of 2662. NOPO-D has an average of approximately 2.0 hydroxyl groups/molecule. NOPO-D corresponds to Structure I, wherein X is —O—, and n=2.
NOPO-E is a 3-functional natural oil polyol prepared from using fatty acids from soy oil in its natural abundance yielding a distribution of about 27 percent weight percent saturated VOB monomer, about 40 percent weight percent mono-hydroxy VOB monomer, and about 33 percent weight percent di-hydroxyl VOB monomer and has a primary hydroxyl content of 100 percent with a hydroxyl number (OH#) of 86 to 92.
It is made by reacting hydroxymethylated soybean fatty acid methyl esters with a 624 molecular weight, poly(ethylene oxide) triol at a 4.1:1 molar ratio, using 500 ppm stannous octoate (commercially available from City Chemical Co.) as the catalyst. The resulting polyester has a viscosity of 2000 cP at 25° C., a hydroxyl equivalent weight of 620, Mn of 1860, Mw of 3612, and a polydispersity of 1.54. NOPO-E has an average of approximately 3.0 hydroxyl groups/molecule. NOPO-E corresponds to Structure I, wherein X is —O—, and n=3.
NOPO-F is a nominally 3-functional natural oil polyol prepared using VOB monomers with an average of 3 hydroxyls per fatty acid derived from high oleic sunflower oil in a distribution of about 10 weight percent saturated VOB monomer, about 85 percent weight percent mono-hydroxy VOB monomer, and about 5 weight percent di-hydroxyl VOB monomer. It is made by reacting these hydroxymethylated soybean fatty acid methyl esters with a 625 molecular weight, ethoxylated glycerin triol at a 625 molar ratio, using 500 ppm stannous octoate (commercially available from City Chemical Co.) as the catalyst. The resulting polyester has a viscosity of 838 cP at 25° C., a hydroxyl equivalent weight of 880 and Mn of 2640 and an OH number of 63. 7 NOPO-F has an average of approximately 3 hydroxyl groups/molecule. NOPO-F corresponds to Structure I, wherein X is —O—, and n=3.
NOPO-G is a 2.0-functional natural oil polyol prepared using VOB monomers with an average of 1.0 hydroxyls per fatty acid derived from fractionated fatty acids yielding a distribution of about 2 percent weight percent saturated VOB monomer, about 95 percent weight percent mono-hydroxy VOB monomer, about 0.5 percent weight percent di-hydroxyl VOB monomer, and about 2 percent cyclic ethers. The monomer distribution is obtained using the method disclosed in copending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, which has been incorporated herein by reference.
It is made by reacting these hydroxymethylated soybean fatty acid methyl esters and CARBOWAX* 600 in a flask at a 4.35:1 molar ratio. The flask is attached to a rotation evaporator, mixed, and heated to 160° C. upon which the flask is flushed with nitrogen and evacuated three to four times, Under a continuous purge of nitrogen and a pressure of about 10 to 20 bar, 0.25 percent dibutyltin diacetate catalyst is added. After about 4 to 6 hours the reaction is stopped by cooling to room temperature. Hyperphosphorous acid (50 percent solution) is then added in a 2:1 weight ratio to tin-catalyst to remove the tin catalyst. The flask is then heated up to 90° C. for two hours while shaking. A fine white precipitation forms. Residual water is removed by adding molecular sieves, and the product dried for about 12-16 hours. The liquid polyol product is then separated from the precipitate and molecular sieves through filtration over celite filter gel. The resulting polyester has a viscosity of 2265 cP at 25° C., an OH number of about 48, Mn of 1900, Mw of 3460, and an Equivalent molecular weight of 1159. NOPO-G has an average of approximately 2.0 hydroxyl groups/molecule. NOPO-G corresponds to Structure I, wherein X is —O—, and n=2.
NOPO-H is made in the same manner as NOPO-G, but with using CARBOWAX* 200 as the initiator at a monol:intitator ratio of about 5:1. The resulting polyester has a viscosity of 2515 cP at 25° C., an OH number of about 42, Mn of 2360, Mw of 3850, and an Equivalent molecular weight of 1321. NOPO-H has an average of approximately 2.0 hydroxyl groups/molecule. NOPO-H corresponds to Structure I, wherein X is —O—, and n=2.
NOPO-I is made in the same manner as NOPO-G, but with using 1,4-dimethylolcyclohexane (available from Fluka) as the initiator at a monol:intitator ratio of about 6.5:1. The resulting polyester has a viscosity of 4160 cP at 25° C., an OH number of about 41, Mn of 2420, Mw of 3830, and an Equivalent molecular weight of 1372. NOPO-I has an average of approximately 2.0 hydroxyl groups/molecule. NOPO-I corresponds to Structure I, wherein X is —O—, and n=2. NOPO-J is made in the same manner as NOPO-G, but with using CARBOWAX* 200 as the initiator at a monol:intitator ratio of about 2.7:1. The resulting polyester has a viscosity of 1080 cP at 25° C., an OH number of about 90 Mn of 1300, Mw of 2480, and an Equivalent molecular weight of 605. NOPO-J has an average of approximately 2.0 hydroxyl groups/molecule. NOPO-J corresponds to Structure I, wherein X is —O—, and n=2.
NOPO-K is made in the same manner as NOPO-G, but with using 1,4-dimethylolcyclohexane as the initiator at a monol:intitator ratio of about 2.7:1. The resulting polyester has a viscosity of 1975 cP at 25° C., an OH number of about 105, Mn of 1130, Mw of 1855, and an Equivalent molecular weight of 531. NOPO-K has an average of approximately 2.0 hydroxyl groups/molecule. NOPO-K corresponds to Structure I, wherein X is —O—, and n=2.
NOPO-L is a 2.0-functional natural oil polyol prepared using VOB monomers with an average of 1.0 hydroxyls per fatty acid derived from fractionated fatty acids yielding a distribution of about 2 percent weight percent saturated VOB monomer, about 95 percent weight percent mono-hydroxy VOB monomer, about 0.5 percent weight percent di-hydroxyl VOB monomer, and about 2 percent cyclic ethers. The monomer distribution is obtained using the method disclosed in copending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, which has been incorporated herein by reference
It is made by reacting these hydroxymethylated soybean fatty acid methyl esters and CARBOWAX* 400 in a three necked flask at a 2:1 molar ratio in the presence of a 0.1 percent dibutyl tin dilaurate catalyst. A water cooled condenser is placed into one of the necks, and a thermocouple for controlling the reaction temperature using a heating mantle into the second. Into the third neck is run a slow purge of nitrogen gas (approximately 1 bubble per second). The speed of the purge is visualized using a mineral oil filled bubbler. The reaction is run between about 180° C. and about 200° C. The extent of the reaction is monitored by evolved methanol and by GPC using a THF mobile phase and calibrated using PEG standards. The resulting polyester has OH number of about 110, and an Equivalent molecular weight of 508. NOPO-L has an average of approximately 2.0 hydroxyl groups/molecule. NOPO-L corresponds to Structure I, wherein X is —O—, and n=2.
NOPO-M is made in the same manner as NOPO-L, but with a monol:intitator ratio of about 5:1. The resulting polyester has an OH number of about 53, and an Equivalent molecular weight of 1058. NOPO-M has an average of approximately 2.0 hydroxyl groups/molecule. NOPO-M corresponds to Structure I, wherein X is —O—, and n=2.
NOPO-N is a 2.0-functional natural oil polyol prepared using VOB monomers with an average of 1.0 hydroxyls per fatty acid derived from fractionated fatty acids yielding a distribution of about 2 percent weight percent saturated VOB monomer, about 93 percent weight percent mono-hydroxy VOB monomer, about 0.5 percent weight percent di-hydroxyl VOB monomer, and about 4 percent cyclic ethers. The monomer distribution is obtained using the method disclosed in copending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, which has been incorporated herein by reference.
It is made by reacting these hydroxymethylated soybean fatty acid methyl esters and UNOXOL* at a 5.99:1 molar ratio in the presence of 500 ppm tin octoate catalyst. The monomers are first loaded into a flask. The monomers are heated to 150° C. under sparge of nitrogen and vacuum. The catalyst is then added and the mixture further heated to 195° C. for about 3 to 6 hours, with the first two hours being at atmospheric pressure and the last four at about 50 mmHg. The mixture is then cooled down to room temperature The resulting polyester has a viscosity of 1940 cP at 25° C., an OH number of about 56, and an Equivalent molecular weight of 999. NOPO-N has an average of approximately 2.0 hydroxyl groups/molecule. NOPO-N corresponds to Structure I, wherein X is —O—, and n=2.
NOPO-O is made in the same manner as NOPO-N, but with 1,6-hexanediol (available from the Sigma-Aldrich Company) at a monol:intitator ratio of about 6.02:1. The resulting polyester has a viscosity of 2330 cP at 25° C., an OH number of about 52, and an Equivalent molecular weight of 1075. NOPO-O has an average of approximately 2.0 hydroxyl groups/molecule. NOPO-O corresponds to Structure I, wherein X is —O—, and n=2.
NCO-1 is a monomeric methylene diisocyanate commercially available from The Dow Chemical Company under the trade designation ISONATE*125M.
NCO-2 is a 27.5 weight percent MDI prepolymer/polymeric blended isocyanate commercially available from The Dow Chemical Company under the trade designation ISONATE* PR 7045.
CARBOWAX* 200 is a 190 to 210 molecular weight, poly(ethylene oxide) glycol, available from The Dow Chemical Company under the trade designation CARBOWAX* PEG 200.
CARBOWAX* 400 is a 380 to 420 molecular weight, poly(ethylene oxide) glycol, available from The Dow Chemical Company under the trade designation CARBOWAX* PEG 400.
CARBOWAX* 600 is a 570 to 630 molecular weight, poly(ethylene oxide) glycol, available from The Dow Chemical Company under the trade designation CARBOWAX* PEG 600.
UNOXOL* Diol is a cycloaliphatic diol that is composed of approximately a 1:1 ratio of (cis, trans)-1,3-cyclohexanedimethanol and (cis, trans)-1,4-cyclohexanedimethanol, available from The Dow Chemical Company under the trade designation UNOXOL* Diol.
CAT-1 is dioctyltin di isooctylmercaptoacetate commercially available from General Electric Company under the trade designation Fomrez™ UL-29.
PRE-1 is a soft segment prepolymer/polymeric MDI blend (50/50 wt percent) of a prepolymer formed from 23 weight percent of MDI and 77 weight percent of a polyol commercially available from The Dow Chemical Company under the trade designation VORANOL* 4703 back blended with a polymeric MDI commercially available from The Dow Chemical Company under the trade designation PAPI™ 7940 isocyanate, the prepolymer, Pre-1, being commercially available from The Dow Chemical Company under the trade designation ISONATE* PR 7045 isocyanate.
POLY-1 is a 4800 molecular weight 12.5 wt percent EO capped glycerin initiated triol commercially available from The Dow Chemical Company under the trade designation VORANOL* 9741 A.
POLY-2 is a 2000 molecular weight 12.5 wt percent EO capped glycerin initiated diol commercially available from The Dow Chemical Company under the trade designation VORANOL* 9287A
POLY-3 is a 400 molecular weight, ethoxylated glycerin initiated triol.
SURF-1 is a surfactant commercially available from General Electric under the trade designation NiaxL5614.
ADD-1 is a water scavender additive which is commercially available from UOP LLC under the trade designation Molsiv 5A.
ADD-2 is calcium carbonate commercially available from Imerys under the trade designation Imerys 105 CaCO₃.
BDO is 1,4-butanediol, available from the Sigma-Aldrich Company.
DIPA is 2′,2-dihydroxy isopropyl-N aniline, available from The Dow Chemical Company under the trade designation VORANOL* 220-530.
Tack free time is the time required at the stated temperature to produce a tack-free polymer. A polymer is considered to be tack-free if, when contacted with a tongue depressor, the polymer releases cleanly from the tongue depressor.
* CARBOWAX, ISONATE, UNOXOL, and VORANOL are trademarks of the Dow Chemical Company.

### Examples 1-2 and Comparative Samples A and B

For each of Examples 1-2 and Comparative Samples A and B, the amounts and types of polyol and isocyanate in Table 1 are combined in a glass reactor having an approximate volume of 200 ml and stirred under a blanket of nitrogen. The polyol and isocyanate are reacted at a temperature of 80° C. uncatalyzed for a period of 4 hours to form a prepolymer. The resulting prepolymer is then characterized for free isocyanate content by the procedure of ASTM d5155 to confirm completion of the reaction. Then the prepolymer is reacted with the amount of 1,4-butanediol (BDO) shown in Table 1, in the presence of 0.01 weight percent of total reaction mixture of dibutyltin dilaurate catalyst commercially available from Air Products under the trade designation Dabco T-12 by combining them in a tri-pour container having a volume of 200 ml and hand mixed using a spatula at a temperature of 50° C. for a period of 10 minutes to initiate urethane reaction. The reaction mixture is then poured into a press measuring 16×16 cm where it is pressed at 140 MPa at 100° C. for a period of 1 hour to form a plaque. The resulting plaque of polyurethane is aged at 25° C. and 50 percent relative humidity for 24 hours before testing for toughness, tensile strength and elongation according to the procedures of ASTM D412 to determine the properties in Table 1.

TABLE 1
PLAQUES OF EXAMPLES 1 AND 2 AND
COMPARATIVE SAMPLES A AND B

| | Example (Ex) or Comparative | | | |
|---|---|---|---|---|
| | Sample (CS) | | | |
| | CS A* | CS B* | Ex 1 | Ex 2 |
| NOPO-A grams | 60 | | | |
| NOPO-B grams | | 60 | | |
| NOPO-C grams | | | 60 | |
| NOPO-D grams | | | | 60 |
| NCO-1 grams | 40 | 40 | 40 | 40 |
| prepolymer theoretical | 10.1 | 11.4 | 10.2 | 11.5 |
| percent NCO | percent | percent | percent | percent |
| Prepolymer measured | 9.9 | 11.2 | 10.0 | 11.4 |
| percentNCO | percent | percent | percent | percent |
| BDO grams | 10.1 | 11.4 | 10.2 | 11.7 |
| Stoichiometric ratio | 1:1.05 | 1:1.05 | 1:1.05 | 1:1.05 |
| prepolymer and BDO | | | | |
| Weight percent hard segment | 46 | 46 | 46 | 46 |
| Toughness kPa | 17000 | 3700 | 25000 | 19000 |
| Tensile strength kPa | 16380 | 9611 | 11804 | 14065 |
| Elongation percent | 150 | 51 | 239 | 192 |

*Comparative Sample, not an example of the invention

The data in Table 1 shows a greater elongation for Examples of the invention made using a higher percentage of monounsaturated fatty acids in making the polyol used in making the prepolymer, that is, in the soft segment. Examples of the invention also show comparable tensile strength. Thus the resulting polymers provide greater toughness as shown by the integrated toughness values. Furthermore, a comparison of thermal mechanical transitions determined by dynamic mechanical testing, that is tan delta and storage modulus determined by DMA show that examples of the invention have sharper thermal mechanical transitions than the comparative samples. Sharp thermal mechanical transitions are indicative of properties such as improved low temperature flexibility and toughness.

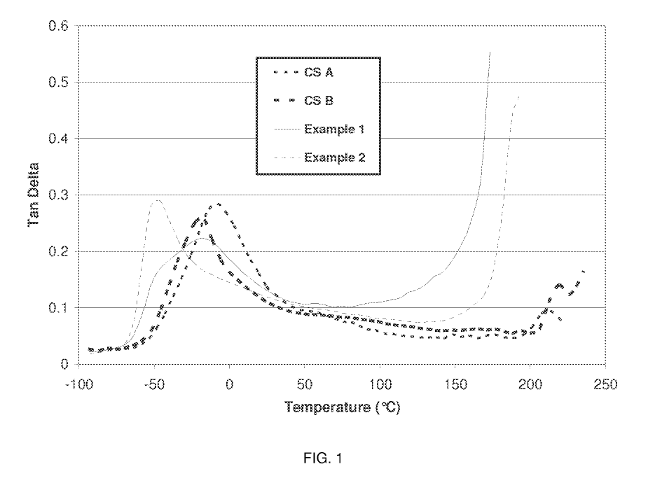

FIG. 1 is a graph of storage modulus against temperature for the elastomers of Examples 1 and 2 and Comparative Samples A and B. The downward slopes of the graphs of Examples 1 and 2 begin before that of Comparative Samples A and B, indicating that the soft segment of Examples 1 and 2 has a lower Tg than that of Comparative Samples A and B.

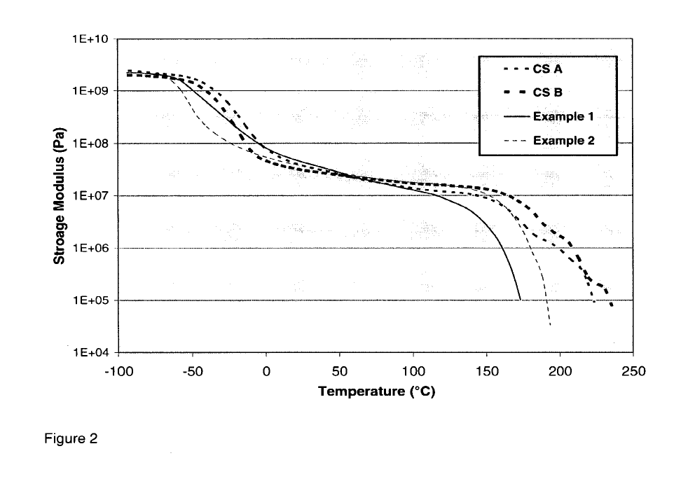

FIG. 2 is a graph of tan delta against temperature for the elastomers of Examples 1 and 2 and Comparative Samples A and B. The elastomer of Example 2 has a steep slope at a temperature of less than about −50° C., whereas the slope of the tan delta plot of Example 2 is less steep and the peak is broader. The rise in tan delta does, however occur at a temperature below −50° C. as contrasted with that of Comparative Samples A and B which begin to rise about −50° C. and show peaks closer to 0° C. This indicates comparative examples A and B have glass transitions near 0° C., while Examples 1 and 2 have glass transitions nearer to −50° C. The lower glass transition correlates to better flexibility and elastomeric properties at low temperatures. The tan deltas of Examples 1 and 2 also show a steep rise between 150 and 200° C. that are not exhibited by Comparative Samples A and B. This indicates polymer flow in Examples 1 and 2 at these temperatures characteristic of more thermoplastic elastomer behavior than in comparative examples A and B.

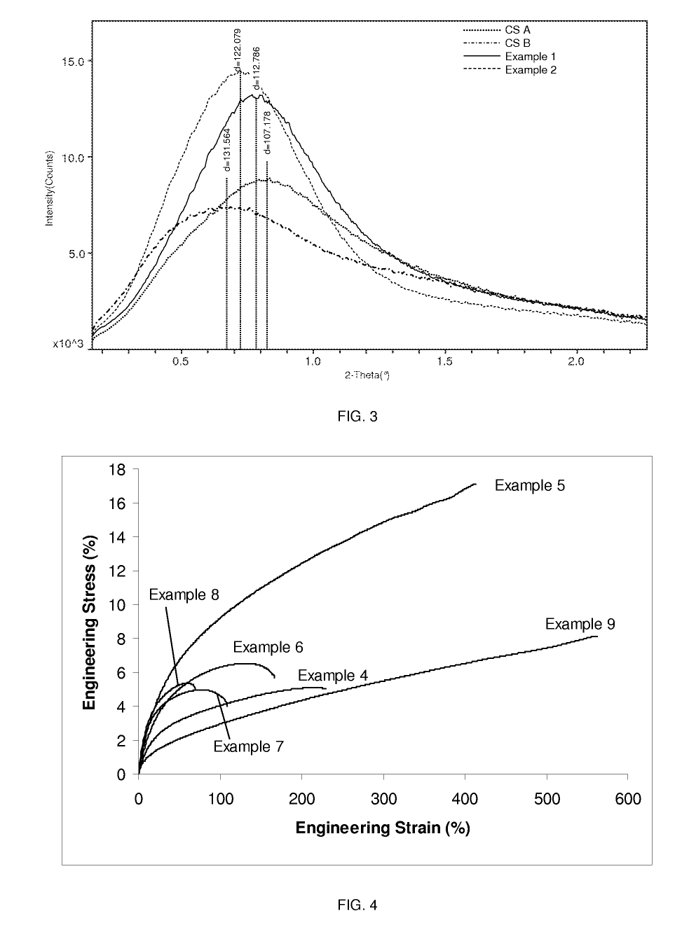

FIG. 3 is a plot of X-ray diffraction intensity against 2 multiplied by the light incidence angle for Comparative Samples A and B and Examples 1 and 2. FIG. 3 shows higher peaks for Examples 1 and 2 than for Comparative Samples A and B. The higher peaks between 0.5 and 1.0×10³ correspond to much greater phase separation of hard and soft segments than the lower peaks. X-ray diffraction shows more phase separation of hard segment from soft segment in the examples of the invention as compared to comparative samples. More distinct phase separation results in improved low temperature flexibility and toughness.

### Example 3 and Comparative Sample C Applied to Carpet

To prepare a carpet coated with a foam of Example 3, a 2 inch (5 cm) frother commercially available from Oakes under the trade designation Oakes Frother, equipped to process multi-component streams, is used to prepare a mechanically froth foam formulation for applying a foam to a polyurethane precoated carpet style nylon 6.6 face tufted through a woven polypropylene primary layer commercially available from Shaw Industries, Inc. under the trade designation Capitol. The formulation is prepared by mixing with a 10 cm cowles blade: 4655g POLY-1, 1781 g NOPO-F, 651 g diethylene glycol, 141.5 g ADD-1, and 7783 g ADD-2. This mixture is referred to as the compounded mixture. The compounded mixture is blended to a temperature of 49° C., poured into a 20 liter pressurized tank commercially available from ITW Binks under the trade designation Binks™ and cooled to 18.3° C.

Into separate vessels are added the following components: NCO-2 isocyanate is added to a 4 l pressurized tank, a blend of 25 wt percent SURF-1 in POLY-2 is added to a 1 l tank; and a 1.0 wt percent blend of CAT-1 in POLY-2 is added to another 1 l tank. The materials are feed into the Oakes Frother at the following feed rates: 212 g/min compounded mixture, 41.7 g/min NCO-2, 4.0 g/min SURF-1 blend, and 1.5 g/min CAT-1 blend. The ingredients are mixed and frothed with 0.33 l/min compressed air to a froth density of 400 g/l. The frothed foam is delivered via hose to the backside of the precoated carpet. The froth is applied to precoated carpet using a blade over bedplate gapped at 3.2 mm. A 0.08 kg/m² nonwoven polyester scrim is laid onto the surface of the froth and the carpet composite is cured in a 121° C. forced air oven for 6 minutes and then cooled to a temperature of 25° C. For controlled tensile testing, a 0.078 mm unfrothed film is applied to a sheer made of glass coated with a polytetrafluoroethylene commercially available from DuPont under the trade designation Teflon™ and cured for 6 minutes in a 121° C. forced air oven.

The procedure for Example 3 is use to prepare the foam coated carpet sample of Comparative Sample C except that Comparative Sample C is made using a formulation where the polyol blend is made with 4691 g POLY-1, 1768 g NOPO-E and 615 g diethylene glycol.

Table 3 shows the ASTM testing results of the films for Comparative Sample C and Example 3

Column 2 of the table lists the ASTM test number for each test except that viscosity is determined using a Brookfield viscometer using a #7 spindle at the designated temperature and rate in revolutions per minute (RPM) (in Table 3, 10° C. at 20 RPM); cure time is recorded as that time from the time a sample is placed in a 129° C. oven until the surface reaches 110 PC; gel time is recorded as that time from addition of the catalyst until the material has a viscosity of at least 100,000 cP as measured using a #7 spindle; and tensile is measured according to procedure of ASTM D412 using an instrument for the purpose commercially available from Illinois Tool Works under the trade designation Instron.

TABLE 3

| | ASTM | Example | |
|---|---|---|---|
| | procedure | CS C | Ex 3 |
| Compound Viscosity | | 18450 | 15200 |
| #6@20, cp 10° C. | | | |
| Cure time, min at 121° C. | | 2.0 | 2.0 |
| Gel time, min | | 10.4 | 11.4 |
| Tensile film results | | | |
| Tensile strength, kPa | ASTM D-412 | 1185 | 1392 |
| Tensile STD*, kPa | | 38 | 124 |
| Elongation @ break, | ASTM D-412 | 112 | 160 |
| percent | | | |
| Elongation STD, percent | | 3.8 | 13 |
| Toughness, N/m² | ASTM D412 | 909,717 | 1,546,520 |
| Toughness, STD* N/m² | | 49621 | 82702 |
| Young's modulus, kPa | ASTM D412 | 2268 | 2220 |
| Young's modulus STD*, | | 52 | 489 |
| kPa | | | |

*STD is standard deviation among

The results in Table 3 show that both elongation and toughness are significantly enhanced by using the high oleic acid content polyol. In this instance a tri-functional polyol is advantageous because using triols or crosslinking results in a more desirable compression set in frothed foams.

### Example 4-9 and Comparative Samples D-G

For each of Examples 4-9 and Comparative Samples D-G, the amounts and types of polyol and isocyanate in Table 4 are combined in a glass reactor having an approximate volume of 140 ml and stirred under a blanket of nitrogen. A drop of benzoyl chloride is added to make the reaction medium slightly acidic. The polyol and isocyanate are reacted at a temperature of 80° C. uncatalyzed for a period of 4 hours to form a prepolymer. The resulting prepolymer is then characterized for free isocyanate content by the procedure of ASTM d5155 to confirm completion of the reaction. Then, the prepolymer is reacted with the amounts and types of chain extender shown in Table 4 at a stoichiometry of 1.05:1. The reaction mixture is then poured into a press measuring 16×16 cm where it is pressed at 140 MPa at 80° C. for a period of 1 hour to form a plaque. The plaque is then taken out of the heated press and placed into an oven for 23 hours at 80° C. to complete the reaction. The resulting plaque of polyurethane is aged at 25° C. and 50 percent relative humidity for 24 hours before testing the thermal behavior, the tensile strength and the dynamic mechanical relaxation The formulations are designed so that the final polyurethane plaques have a hard segment content of about 40 percent

TABLE 4
PLAQUES OF EXAMPLES 4-9 AND COMPARATIVE SAMPLES D-G

| Ex. | | | Polyol | | | | | |
|---|---|---|---|---|---|---|---|---|
| or | | | Equiv. | | | | Chain | Plaque |
| Cmp. | | | Mol. | Polyol | NCO-1 | Chain | Ext. | Physical |
| Ex | Polyol | Polyol Initiator | Weight | (g) | (g) | Ext. | (g) | state |
| 4 | NOPO-L | CARBOWAX* | 508 | 88.53 | 51.61 | BDO | 9.87 | Solid |
| | | 400 | | | | | | |
| 5 | NOPO-K | 1,4- | 531 | 88.53 | 51.34 | BDO | 10.12 | Solid |
| | | dimethylolcyclohexane | | | | | | |
| 6 | NOPO-J | CARBOWAX* | 605 | 88.56 | 50.45 | BDO | 10.99 | Solid |
| | | 200 | | | | | | |
| 7 | NOPO-G | CARBOWAX* | 1159 | 88.62 | 48.35 | BDO | 13.03 | Solid |
| | | 600 | | | | | | |
| 8 | NOPO-M | CARBOWAX* | 1058 | 88.61 | 48.5 | BDO | 12.89 | Solid |
| | | 400 | | | | | | |
| 9 | NOPO-N | UNOXOL | 999 | 88.88 | 39.19 | DIPA | 21.93 | Solid |
| D | NOPO-H | CARBOWAX* | 1321 | 88.63 | 48.05 | BDO | 13.33 | Semi-solid |
| | | 200 | | | | | | |
| E | NOPO-O | Hexanediol | 1075 | 88.62 | 48.45 | BDO | 12.93 | Viscous |
| | | | | | | | | liquid |
| F | NOPO-N | UNOXOL | 999 | 88.61 | 48.67 | BDO | 12.72 | Viscous |
| | | | | | | | | liquid |
| G | NOPO-I | 1,4- | 1372 | 88.63 | 47.84 | BDO | 13.53 | Viscous |
| | | dimethylolcyclohexane | | | | | | liquid |

Table 4 shows the physical state of the plaques after 1 hour in the 80° C. press and 23 hours in the 80° C. oven. The polyurethane plaques (comparative examples E-G) made from hydrophobic initiators (hexanediol, UNOXOL, and 1,4-dimethylolcyclohexane) initiated polyols with equivalent weights of around 1000, are viscous melts which do not posses mechanical strength. However, if the polyol equivalent molecular weight is reduced to around 500, the plaque (Example 5) is a solid elastomer and has good mechanical strength. If a hydrophilic initiator (CARBOWAX* 400 or CARBOWAX* 600) is used to make polyol with high equivalent molecular weight (around 1000), the plaque (Examples 7 and 8)) is a solid elastomer and has good mechanical strength. The PU made from CARBOWAX* 200 initiated polyol is on the borderline between viscous melt and solid, as polyol made from CARBOWAX* 200 is less hydrophilic than that of CARBOWAX* 400 and CARBOWAX* 600, but more hydrophilic than that of a hydrophobic initiator. If 2′,2 dihydroxy isopropyl-N aniline (DIPA) is used as the chain extender, the final plaque (Example 9) is a solid elastomer and has good mechanical strength, even though the polyol has about a 1000 equivalent molecular weight and is made using a hydrophobic initiator.

FIG. 4 shows the tensile stress strain curves of the polyurethane plaques which are solid elastomers (Examples 4-9). The stress-strain behavior in uniaxial tension is measured according to ASTM 1708 using microtensile specimens cut from the films. Specimens are stretched at a strain rate of 22.25 mm/min. The grip separation is 22.25 mm, which includes the fillet section. Engineering strain is calculated from the crosshead displacement. Engineering stress is defined conventionally as the force per initial unit cross-sectional area. The polyurethane plaque made with the 1,4-dimethylolcyclohexane initiated polyol with 531 equivalent molecular weight (Example 5) displays a high elongation before breaking (>400 percent) and high tensile strength (>16 Pa). The PU made from DIPA as chain extender (Example 9) also has high elongation to break (>550 percent), even though the polyol has around a 1000 equivalent molecular weight and was made from a more hydrophobic initiator, Unoxol. Although the PU made from hydrophilic initiator initiated polyols (Examples 4, 7, and 8) are solid, they have lower elongation to break than the polyurethane plaque made from 1, 4 CHDME initiated polyol with 531 equivalent molecular weight (Example 5).

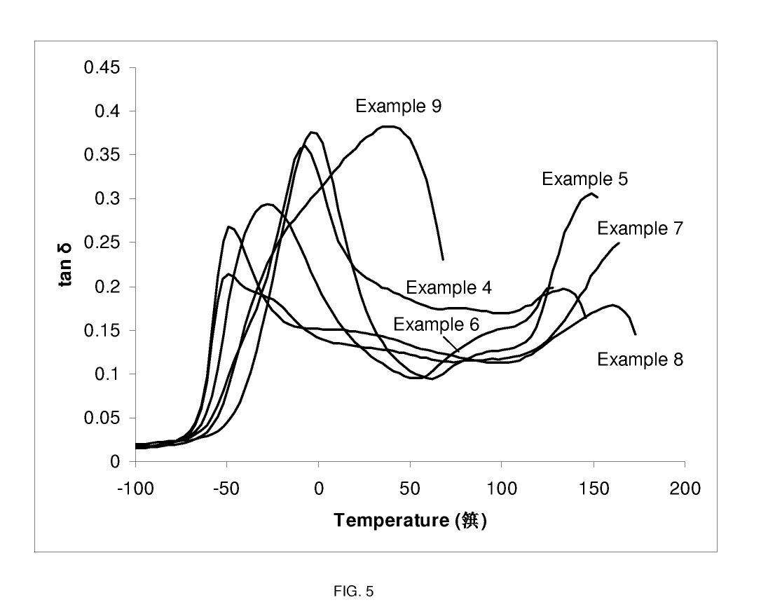

FIG. 5 is a graph of tan delta against temperature for the polyurethane elastomers Examples 4-9. Dynamic mechanical relaxation spectroscopy of thin films is obtained in torsion mode using an ARES rheometer. A frequency of 1 Hz is used for the tests and each test spans a temperature range of −40 to 200° C. The grip to grip distance is 15 mm. Data related to storage and loss modulus, tan delta and torque are recorded for analysis. For the polyurethane elastomers made with BDO as the chain extender (Examples 4-8), the polyurethane elastomers made from polyol with an equivalent molecular weight at around 500 have a higher Tg than those from polyol with an equivalent molecular weight at around 1000. This is because the polyurethane from polyol with the lower equivalent molecular weight does not have enough phase separation between hard and soft segments, thus had higher soft segment Tg. The polyurethane elastomer made with DIPA (Example 9) as the chain extender has the highest Tg of Examples 4-9.

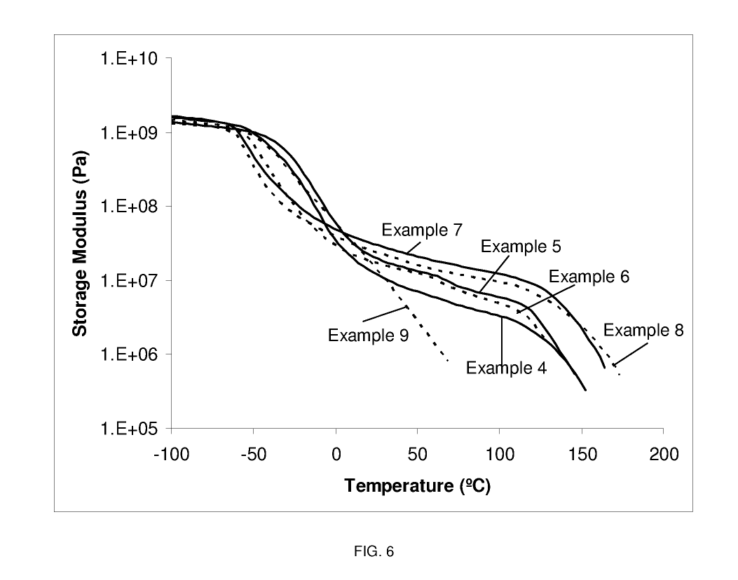

FIG. 6 shows the storage modulus of the polyurethane elastomers Examples 4-9. For the polyurethane elastomers made with BDO as the chain extender (Examples 4-8), the polyurethane elastomer made from polyol with equivalent molecular weight at around 1000 have higher plateau modulus than those made from polyol with equivalent molecular weight at around 500. This is because the polyurethane elastomers made from polyol with the higher equivalent molecular weight have better phase separation than those from polyol made with lower equivalent molecular weight. The polyurethane elastomer made with DIPA as the chain extender (Example 9) does not have a plateau, as the hard segment does not phase separate out to form crystals.

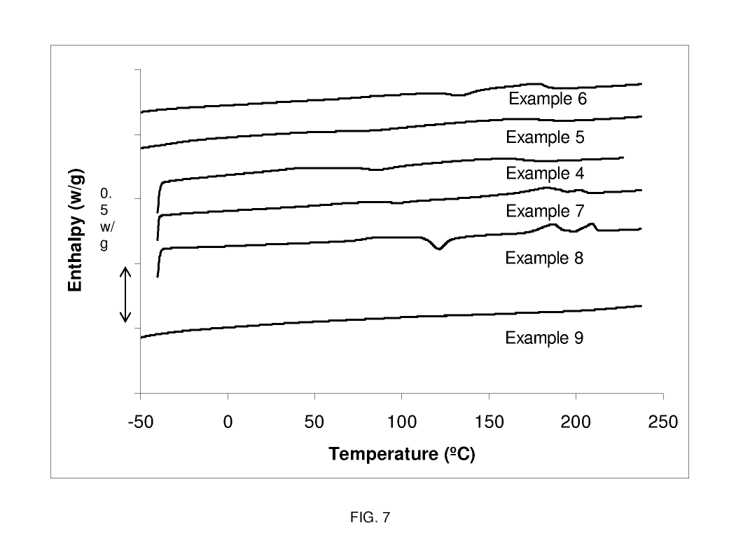

FIG. 7 shows the second melting curves of the polyurethane elastomers Examples 4-9. A differential scanning calorimeter (DSC, model QC1000, TA instrument) is used to perform the thermal analysis. Specimens weighing between 5 and 10 mg are heated from −40 to 240° C. at a rate of 10° C./min in an open alumina sample pan, cooled from 240 to −40° C. at a rate of 10° C./min, then heated again from −40 to 240° C. at a rate of 10° C./min. For the polyurethane elastomers made with BDO as the chain extender (Examples 4-8), the polyurethane elastomer made from polyol with equivalent molecular weight at around 1000, (Examples 7 and 8) have clear melting peak. In contrast, the polyurethane elastomers made from polyol with equivalent molecular weight around 500 had much smaller and less defined melting peak (examples 4-6). The polyurethane elastomer made from polyol with equivalent molecular weight around 1000 also have higher melting points than those made from polyol with equivalent molecular weight around 500. The polyurethane elastomers made with DI PA as chain extender (Example 9) does not show any melting peak.

Embodiments of the invention include the following:

1. A prepolymer or elastomer which is the reaction product of (a) at least one polyester polyol or fatty acid derived polyol which is the reaction product of at least one initiator and a mixture of fatty acids or derivatives of fatty acids comprising at least about any of 45, 80, 85 or 90 weight percent monounsaturated fatty acids or derivatives thereof, (b) optionally, at least one polyol which is different from the polyol of (a); and (c) at least one isocyanate compound (herein after isocyanate) having an average of at least about 1.8 isocyanate groups per molecule.
2. A polyol composition comprising (a) at least one polyester polyol or fatty acid derived polyol which is the reaction product of at least one initiator and a mixture of fatty acids or derivatives of fatty acids comprising at least about any of 45, 80, 85 or 90 weight percent monounsaturated fatty acids or derivatives thereof in an amount of from at least about any of 10, 25, or 50 to at most about 100 weight percent, and (b) at least one polyol which is different from the polyol of (a), that is not the reaction product of at least one initiator and a mixture of fatty acids or derivatives of fatty acids comprising at least about any of 45, 80, 85 or 90 weight percent monounsaturated fatty acids or derivatives thereof in an amount of from at least about any of 0, 10, 20 or 30 to at most about any of 90, 50, 75 or 10 weight percent based on the total polyol weight, which composition optionally also contains additives, catalysts, and the like.
3. A prepolymer which is the reaction product of at least one composition or fatty acid derived polyol described in any of the preceding embodiments and at least one aromatic compound having an average of more than one isocyanate group, preferably at a stoichiometric ratio of isocyanate groups to hydroxyl groups of at least about 1.05:1 to 10:1.
4. An elastomer comprising the reaction product of: (i) at least one polyol composition comprising the fatty acid derived polyol which is the reaction product of at least one initiator and a mixture of fatty acids or derivatives of fatty acids comprising at least about any of 45, 80, 85 or 90 weight percent monounsaturated fatty acids or derivatives thereof; and (ii) at least one isocyanate having an average functionality of at least about 1.8; and (iii) at least one chain extender selected from the group consisting of monomeric diols of from 2 to 20 carbon atoms and amines of from 2 to 20 carbon atoms.
5. A process comprising admixing (i) at least one polyol composition comprising the fatty acid derived polyol which is the reaction product of at least one initiator and a mixture of fatty acids or derivatives of fatty acids comprising at least about any of 45, 80, 85 or 90 weight percent monounsaturated fatty acids or derivatives thereof; and (ii) at least one isocyanate having an average functionality of at least about 1.8 under reaction conditions to form a reaction product which is a polymer or prepolymer is formed therefrom.
6. The process of a preceding embodiment wherein (1) (iii) at least one chain extender selected from the group consisting of monomeric diols of from 2 to 20 carbon atoms and amines of from 2 to 20 carbon atoms is additionally admixed with (i) and (ii).
7. The process of embodiment Error! Reference source not found. wherein the reaction product is a prepolymer and there is a subsequent step of (2) adding (iii) at least one chain extender selected from the group consisting of monomeric diols of from 2 to 20 carbon atoms and amines of from 2 to 20 carbon atoms under reaction conditions such that a polymer is formed.
8. The elastomer, polymer, process, composition, prepolymer or reaction product of the composition or prepolymer of any of the preceding embodiments wherein at least one fatty acid derived polyol is used alone or with at least one other fatty acid derived polyol as described in any of the preceding embodiments.
9. The elastomer, polymer, process, composition, prepolymer or reaction product of the composition or prepolymer of any of the preceding embodiments wherein at least one fatty acid derived polyol is used in a mixture with at least one polyol different from the fatty acid derived polyol, preferably at least one polyether, polyester, polyacrylic, polycarbonate or combination thereof; independently preferably wherein the at least one polyol different from a fatty acid derived polyol or combination thereof is present in an amount of from at least about any of 10, 20, 30, or 50 to at most about any of 90, 50, 75 or 10 weight percent based on the total polyol weight.
10. A polymer which is the reaction product of at least one fatty acid derived polyol or polyol composition described in a preceding embodiment and at least a stoichiometric amount of at least one compound having at least two functional groups reactive with hydroxyl groups or a combination thereof, preferably wherein the functional groups are primary hydroxyl groups; or which is the reaction product of a prepolymer of any of the preceding embodiments and at least one chain extender; preferably wherein the chain extender or combination thereof is present in at least about a stoichiometric amount.
11. The elastomer, polymer, process, composition, prepolymer or reaction product of the composition or prepolymer of any of the preceding embodiments wherein at least one chain extender, and crosslinker, if any, are used at an isocyanate index of from 95 to 105, preferably about 100.
12. The elastomer, polymer, process, composition, prepolymer or reaction product of the composition or prepolymer of any previous embodiment wherein the derivative of a fatty acid is the ester, preferably alkyl ester, more preferably of from 1 to 3 carbon atoms, most preferably the methyl ester, anhydride, combination thereof.
13. The elastomer, polymer, process, composition, prepolymer or reaction product of the composition or prepolymer of any of the preceding embodiments wherein unsaturation in the fatty acid is converted to hydroxyl groups, optionally through another group that can be converted to a hydroxyl group, for instance an aldehyde group, preferably by hydroformylation.
14. The elastomer, polymer, process, composition, prepolymer or reaction product of the composition or prepolymer of any of the preceding embodiments wherein the fatty acid derived polyol advantageously has an average number of functional groups reactive with aromatic isocyanate groups, preferably hydroxyl groups per molecule of at least about any of 1.7, 1.8, 1.9, or 1.95, and preferably at most about any of 3.5, 3, or 2.
15. The elastomer, polymer, process, composition, prepolymer or reaction product of the composition or prepolymer of any of the preceding embodiments wherein the fatty acid derived polyol advantageously has at least about any of 45, 65, 80, 85 and up to 100 percent by weight molecules having 2 groups reactive with aromatic isocyanate groups, preferably hydroxyl groups.
16. The elastomer, polymer, process, composition, prepolymer or reaction product of the composition or prepolymer of any of the preceding embodiments wherein the fatty acid derived polyol has an number average molecular weight at least sufficient to form elastomers, that is preferably at least about any of 1000, 1500, or 2000, and preferably at most about any of 10000, 8000, or 4000.
17. The elastomer, polymer, process, composition, prepolymer or reaction product of the composition or prepolymer of any of the preceding embodiments wherein the fatty acid derived polyol is produced using at least one initiator which is preferably a polyol, hydroxylamine or polyamine initiator compound or combination thereof advantageously having an average of at least about any of 1.7, 1.9, 1.95, 2.0, and preferably at most about any of 4.0, 3.5, or 3.0, most preferably in one embodiment about 2 and most preferably in an alternative embodiment about 3, hydroxyl, primary amine and/or secondary amine groups/molecule.
18. The elastomer, polymer, process, composition, prepolymer or reaction product of the composition or prepolymer of any of the preceding embodiments wherein at least one resulting hydroxymethyl-containing polyester polyol contains an average of at least about any of 1, 2, 2.5, or 3, and preferably at most about any of 16, 13, or 7 repeating units derived from the hydroxymethyl-group containing fatty acid or ester thereof for each hydroxyl, primary amine and secondary amine groups in the initiator compound.
19. The elastomer, polymer, process, composition, prepolymer or reaction product of the composition or prepolymer of any of the preceding embodiments wherein at least one resulting hydroxymethyl-containing polyester polyol has an molecular weight of at least about any of 1000, 1500, 1750, or 2000, and preferably at most about any of 10000, 8000, or 4000.
20. The elastomer, polymer, process, composition, prepolymer or reaction product of the composition or prepolymer of any of the preceding embodiments wherein at least one resulting hydroxymethyl-containing polyester polyol has an equivalent weight of preferably at least about any of 500, 750, or 1000, and preferably at most about any of 5000, 4000, or 2000.
21. The elastomer, polymer, process, composition, prepolymer or reaction product of the composition or prepolymer of any of the preceding embodiments wherein at least one initiator reactive species on the initiator is at least as reactive toward the methyl ester as the hydroxyl on the monomer itself, preferably has a reactivity at least equal to that of a primary hydroxyl group.
22. The elastomer, polymer, process, composition, prepolymer or reaction product of the composition or prepolymer of any of the preceding embodiments wherein at least one resulting hydroxymethyl-containing polyester polyol advantageously is a mixture of compounds having the following average structure (Structure 1):

[H—X]₍ₙ₋ₚ₎—R—[X—Z]ₚ (I)

wherein R is the residue of an initiator compound having n hydroxyl and/or primary or secondary amine groups, where n is at least two; each X is independently —O—, —NH— or —NR′— in which R′ is an inertly substituted alkyl, aryl, cycloalkyl, or aralkyl group, p is a number from 1 to preferably about 16 representing the average number of [X—Z] groups per hydroxymethyl-containing polyester polyol molecule, Z is a linear or branched chain comprising residues of fatty acids. “Inertly substituted” groups are groups that do not react with an isocyanate groups and which do not otherwise engage in side reactions during the preparation of the hydroxymethyl-group containing polyester polyol.
23. The elastomer, polymer, process, composition, prepolymer or reaction product of the composition or prepolymer of any of the preceding embodiments wherein in at least one compound of structure 1, n is preferably t least about 2 or 3 to at most about any of 8, 6, or 5, and most preferably about 2 in one embodiment or alternatively about 3 in another embodiment.
24. The elastomer, polymer, process, composition, prepolymer or reaction product of the composition or prepolymer of any of the preceding embodiments wherein in at least one compound of Structure 1 each X is preferably —O—. The total average number of fatty acid residues per hydroxymethylated polyol molecule is preferably at least 1.5 times the value of n, such from 1.5 to 10 times the value of n, about 2 to 10 times the value of n or from 2 to 5 times the value of n.
25. The elastomer, polymer, process, composition, prepolymer or reaction product of the composition or prepolymer of any of the preceding embodiments wherein at least one initiator contains two or more hydroxyl, primary amine or secondary amine groups, preferably a glycol, polyol, an alkanol amine or a polyamine, more preferably polyols or short chain aliphatic diols, most preferably 1,6 hexane diol, 1,4-butane diol, 1,3-cyclohexanedimethanol, and 1,4-cyclohexanedimethanol; or alkoxylated polymers of ethylene oxide and/or propylene oxide, ethoxylated, polyhydroxyl compounds, especially glycerin, sucrose, or combinations thereof, preferably having a molecular weight of advantageously at least about any of 60, 80, or 100 and preferably at most about any of 2000, 1000, or 800.
26. The elastomer, polymer, process, composition, prepolymer or reaction product of the composition or prepolymer of any of the preceding embodiments wherein in at least one compound of Structure 1, Z corresponds to the following Structure 2:

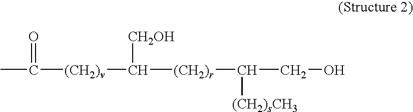

where v, r and s are integers and v is greater than 3, r is greater than or equal to zero, s is greater than or equal to zero, and v+r+s is from 10 to 18.
27. The elastomer, polymer, process, composition, prepolymer or reaction product of the composition or prepolymer of any of the preceding embodiments wherein a polyol composition comprising at least one fatty acid derived polyol as described in any of the preceding embodiments is reacted with at least one isocyanate having an average of at least about any of 1.8 or 2.0 and preferably at most about any of 4, 3, or 2.7, preferably aromatic polyisocyanates, more preferably selected from m-phenylene diisocyanate, 2,4- and/or 2,6-toluene diisocyanate (TDI), the various isomers of diphenylmethanediisocyanate (MDI), and polyisocyanates having more than 2 isocyanate groups, preferably MDI and derivatives of MDI such as biuret-modified “liquid” MDI products and polymeric MDI (PMDI), 1,3 and 1,4-(bis isocyanatomethyl)cyclohexane, isophorone diisocyanate (IPDI), hexamethylene diisocyanate (HDI), bis(4-isocyanatocyclohexyl)methane or 4,4′ dimethylene dicyclohexyl diisocyanate (H12MDI), and the like and combinations thereof, as well as mixtures of the 2,4- and 2,6-isomers of TDI, with isomers of TDI more preferred, and in some embodiments in a 65/35 weight percent mixture of the 2,4 isomer to the 2,6 TDI isomer, in other embodiments a 80/20 weight percent mixture of the 2,4 isomer to the 2,6 TDI isomer most preferred.
28. The elastomer, polymer, process, composition, prepolymer or reaction product of the composition or prepolymer of any of the preceding embodiments wherein at least one elastomer is prepared by a prepolymer process.
29. The elastomer, polymer, process, composition, prepolymer or reaction product of the composition or prepolymer of any of the preceding embodiments wherein at least one the polyol composition or mixture is reacted with excess di- or polyisocyanate to form an isocyanate-terminated prepolymer containing an average of 2 or more isocyanate groups per molecule.
30. The elastomer, polymer, process, composition, prepolymer or reaction product of the composition or prepolymer of any of the preceding embodiments wherein at least one isocyanate is used in a stoichiometric excess (NCO:OH) of at least about any of 1.05:1, 1.10:1, or 1.20:1, and preferably at most about any of 10:1, 8:1, or 5:1
31. The elastomer, polymer, process, composition, prepolymer or reaction product of the composition or prepolymer of any of the preceding embodiments wherein at least one prepolymer has an equivalent weight of at least about any of 100 or 300, and preferably at most about any of 30000, 20000, or 10000 grams per isocyanate group.
32. The elastomer, polymer, process, composition, prepolymer or reaction product of the composition or prepolymer of any of the preceding embodiments wherein at least one prepolymer preparation is catalyzed, by at least one tin catalyst, preferably selected from dibutyltin diacetate, dibutyltin dilaurate, dibutyltin oxide or a combination thereof; independently preferably in amounts at least about any of 10, or 50 and preferably at most about any of 5000, 2500, or 1000 ppm by weight based on weight of prepolymer.
33. The elastomer, polymer, process, composition, prepolymer or reaction product of the composition or prepolymer of any of the preceding embodiments wherein at least one prepolymer polyol component is augmented with at least one hydroxyl-functional polyol, preferably other than a polyoxyalkylene polyol, more preferably at least one polyester polyol, polycaprolactone polyol, polytetramethylene ether glycol (PTMEG), polycarbonate polyol or combinations thereof.
34. The elastomer, polymer, process, composition, prepolymer or reaction product of the composition or prepolymer of any of the preceding embodiments wherein at least one catalyst is used to facilitate reaction of fatty acid derived polyol and isocyanate, preferably selected from at least one tertiary amine; tertiary phosphine, metal chelate, acid metal salts of strong acids, strong base, metal alcoholate, metal phenolate, the reaction product at least one alcoholate with at least one carboxylic acid, beta-diketone, (N,N-dialkylamino)alcohol; alkaline earth metal, Bi, Pb, Sn or Al carboxylate salt; tetravalent tin compound, tri- or pentavalent bismuth, antimony or arsenic compound or combination thereof.
35. The elastomer, polymer, process, composition, prepolymer or reaction product of the composition or prepolymer of any of the preceding embodiments wherein at least one, preferably, each catalyst is used in an amount of from 10 ppm to 1 weight percent by weight of the resulting polymer.
36. The elastomer, polymer, process, composition, prepolymer or reaction product of the composition or prepolymer of any of the preceding embodiments wherein at least one prepolymer is reacted with at least one chain extender to produce hard segments in the resulting elastomeric polymer, preferably polyurethane.
37. The elastomer, polymer, process, composition, prepolymer or reaction product of the composition or prepolymer of any of the preceding embodiments wherein at least one chain extender or chain extenders, preferably all chain extenders used, have an equivalent weight per isocyanate-reactive group of at least about 9 and preferably at most about 300 or 200.
38. The elastomer, polymer, process, composition, prepolymer or reaction product of the composition or prepolymer of any of the preceding embodiments wherein at least one chain extender, preferably all chain extenders used have isocyanate-reactive groups selected from aliphatic alcohol, primary amine or secondary amine groups or a combination thereof, preferably aliphatic alcohol groups.
39. The elastomer, polymer, process, composition, prepolymer or reaction product of the composition or prepolymer of any of the preceding embodiments wherein at least one chain extender, crosslinkers, or combination thereof, preferably all chain extenders and crosslinkers, are selected from water, alkylene glycols, glycol ethers, cyclohexane dimethanol; glycerine; trimethylolpropane; triethanolamine; diethanol amine, aromatic diamines and combinations thereof, preferably from diols, diamines and combinations thereof, more preferably aliphatic and cycloaliphatic glycols and oligomeric polyoxyalkylene diols, most preferably 1,6-hexanediol, 1,4-butanediol and combinations thereof, especially the 1, 4 butanediol.
40. The elastomer, polymer, process, composition, prepolymer or reaction product of the composition or prepolymer of any of the preceding embodiments wherein at least one polymer or elastomer has a hard segment content of at least about any of 10, 15, or 20 and preferably at most about any of 60, 55 or 50 weight percent.
41. The elastomer, polymer, process, composition, prepolymer or reaction product of the composition or prepolymer of any of the preceding embodiments wherein at least one is prepared by a one shot process.
42. The elastomer, polymer, process, composition, prepolymer or reaction product of the composition or prepolymer of any of the preceding embodiments wherein the soft segment has a glass transition temperature (Tg) below the expected use temperature and a hard segment having a softening point or a melt temperature (Tm) above the expected use temperature, preferably both, more preferably where in the Tg or Tm are at least about any of 2, 5, 10, 20, 30, 40 or 50 degrees centigrade above or below the use temperature, respectively, most preferably both.
43. The elastomer, polymer, process, composition, prepolymer or reaction product of the composition or prepolymer of any of the preceding embodiments wherein at least one crosslinker is used, preferably selected from glycerine, trimethylolpropane, an oxyalkylated oligomer of glycerine or trimethylolpropane, N,N,N′,N′-tetrakis[2-hydroxyethyl or 2-hydroxypropyl]-ethylene diamine, an oxyalkylated aliphatic and aromatic diamine, aminophenol, and combinations thereof, more preferably from triethanolamine, tripropanolamine and combinations thereof.
44. The elastomer, polymer, process, composition, prepolymer or reaction product of the composition or prepolymer of any of the preceding embodiments wherein a crosslinker is not used.
45. The elastomer, polymer, process, composition, prepolymer or reaction product of the composition or prepolymer of any of the preceding embodiments wherein at least one composition or polyol used to make the prepolymer, polymer or elastomer comprises at least one reactive, volatile, chemical or physical blowing agent or combination thereof, preferably at least one reactive blowing agent, preferably in an amount of at least about any of 0.1 or 0.2 and more preferably at most about any of 1.0 or 0.4 weight percent, more preferably water, CO₂, hydrocarbons, fluorocarbons, hydrofluorocarbons, chlorocarbons, chlorofluorocarbons and hydrochlorofluorocarbons, ketones, esters or combinations thereof.
46. The elastomer, polymer, process, composition, prepolymer or reaction product of the composition or prepolymer of any of the preceding embodiments wherein the prepolymer has an isocyanate group content of at least about any of 8, 10, 13 and more preferably at most about any of 25, 22, or 15 weight percent.
47. The elastomer, polymer, process, composition, prepolymer or reaction product of the composition or prepolymer of any of the preceding embodiments wherein the prepolymer is at least one of crosslinked or diol extended, more preferably both, most preferably with the crosslinking provided by, in addition to a glycol chain extender, a tri- or higher functional, low unsaturation polyol in the polyol composition.
48. The elastomer, polymer, process, composition, prepolymer or reaction product of the composition or prepolymer of any of the preceding embodiments wherein less than about 0.5 pphp of water is used.
49. The elastomer, polymer, process, composition, prepolymer or reaction product of the composition or prepolymer of any of the preceding embodiments wherein the composition or polyol composition additionally contains at least one additive, preferably at least one antioxidant, UV stabilizer, plasticizer, emulsifier, thickener, flame retardant, surfactant, cell opener, colorant, filler, load bearing enhancement additive, internal mold release agent, antistatic agent, antimicrobial agent, additive for reducing combustibility, dispersant, foaming agent, drying agent, filler, pigment or combination thereof.
50. The elastomer, polymer, process, composition, prepolymer or reaction product of the composition or prepolymer of any of the preceding embodiments which has a Tg of less than about −20° C.
51. The elastomer, polymer, process, composition, prepolymer or reaction product of the composition or prepolymer of any of the preceding embodiments which has an elongation at break as measured according to the procedures of ASTM D412 of at least about any of 200, 220, 240, or 260 and preferably at most about any of 2000, 1700, or 1500 percent.
52. The elastomer, polymer, process, composition, prepolymer or reaction product of the composition or prepolymer of any of the preceding embodiments which has lower Tg than an elastomer produced by the same process using the same materials except that the polyol is formed from a fatty acid mixture having less than about 45 weight percent monounsaturated fatty acids or derivatives thereof.
53. The elastomer, polymer, process, composition, prepolymer or reaction product of the composition or prepolymer of any of the preceding embodiments a slope of the plateau of the tan delta plot which is 0 degrees.
54. The elastomer, polymer, process, composition, prepolymer or reaction product of the composition or prepolymer of any of the preceding embodiments which has a tan delta with a steeper slope than and with a peak at a lower temperature than elastomers produced by the same process using the same materials except that the polyol is formed from a fatty acid mixture having less than about 45 weight percent monounsaturated fatty acids or derivatives thereof.
55. The elastomer, polymer, process, composition, prepolymer or reaction product of the composition or prepolymer of any of the preceding embodiments which have at least one, preferably at least two, more advantageously at least 3, most advantageously at least 4, preferably 5, of the following properties:
(a) a tensile strength measured in accordance with ASTM D412 of at least about any of 1400 pKa, 3000 kPa, 4000 kPa, or 7000 kPa;
(b) an elongation measured in accordance with ASTM D412 of at least about any of 100 percent 150 percent, 200 percent, or 250 percent;
(c) a Tg as determined by tan delta peak via dynamic mechanical analysis (DMA) tests using an instrument comparable to the instrument commercially available from TA Instruments under the trade designation RSA III using a rectangular geometry in tension according to manufacturer's directions and ramped from an initial temperature of −90 PC to a final temperature of 250° C. at 2° C./minute of preferably at most about any of −20, −30, or −35° C.;
(d) if thermoplastic, a Tm of at least about any of 80, 90, 95, or 100° C.; or
(e) a toughness defined as the total energy required to break the polymer specimen measured via integration of the stress versus strain curve in accordance with ASTM D412 of at least about 700, 2000, 5000 kPa, or 10000 kPa.
56. An article comprising the reaction product of at least one composition or prepolymer of any of the preceding embodiments or at least one polymer or elastomer of any of the preceding embodiments or the elastomer or prepolymer prepared by the process of any of the preceding embodiments.
57. An article of the preceding embodiment in the form of at least one molded object, thermoplastic polyurethane, foam (open or closed cell or a combination thereof), fiber, film, sheet, tube, roll, roller, gear, microcellular elastomer, shoe sole, a shoe insole, a vibration or wave energy absorbing material, flexible mechanical coupling, drive wheel; mallet or hammer head; roller for printing, roller for conveying; shock absorbent pad or bumper; tire, caster wheel, belting or coating thereon, furnishing, carpet backing, seating, cushioning, adhesive, sealant, coating, potting material, casting material, dispersion, mechanically frothed foam, carpet backing, foam gasket, foam insert, mat, or combination thereof.
58. An elastomer or coating comprising at least one composition, polymer, elastomer, prepolymer or reaction product thereof described in any of the preceding embodiments in a castable, sprayable, or injectable form.
59. A coating composition comprising the reaction product of at least one composition or prepolymer of any of the preceding embodiments or at least one polymer of any of the preceding embodiments, preferably wherein the coating composition is in the form of a solution or dispersion or combination thereof.
60. A coating or coating composition of or comprising any of the preceding embodiments wherein the resulting coating is abrasion resistant.
61. A coating composition of any of the preceding embodiments which is an ink, preferably for printing or coating.
62. An article coated with the coating of any of the preceding embodiments, preferably wherein the coated article is selected from at least one synthetic leather, artificial leather, fiber, woven fabric, nonwoven fabric, a magnetic tape, electromagnetic sealed object, metal or a combination thereof.
63. A thermoplastic polyurethane prepared from a composition, prepolymer or polymer of any of the preceding embodiments, preferably a mixture comprising at least one organic diisocyanate, at least one polymeric diol and at least one difunctional extender.
64. The elastomer, polymer, process, composition, prepolymer or reaction product of the composition or prepolymer of any of the preceding embodiments where the initiator is hydrophobic and the at least one polyester polyol or fatty acid derived polyol has an equivalent molecular weight of less than about 750.
65. The elastomer, polymer, process, composition, prepolymer or reaction product of the composition or prepolymer of any of the preceding embodiments where the initiator includes at least one of 1,6-hexanediol, 1,4-dimethylolcyclo-hexane, a mixture of (cis, trans)-1,3-cyclohexanedimethanol and (cis,trans)-1,4-cyclohexanedimethanol, and 1,4 butanediol.
66. The elastomer, polymer, process, composition, prepolymer or reaction product of the composition or prepolymer of any of the preceding embodiments where the initiator is poly(ethylene oxide) glycol with molecular weight higher than 400 and the at least one polyester polyol or fatty acid derived polyol has an equivalent molecular weight between 500 and 1200.
67. The elastomer, polymer, process, composition, prepolymer or reaction product of the composition or prepolymer of any of the preceding embodiments where the initiator is hydrophobic, the at least one polyester polyol or fatty acid derived polyol has an equivalent molecular weight of at least than about 900, and the at least one chain extender is at least one of 2′,2-dihydroxy isopropyl-N aniline and 2-ethyl-1,3,-hexanediol.

While the foregoing is directed to embodiments of the present invention, other and further embodiments of the invention may be devised without departing from the basic scope thereof, and the scope thereof is determined by the claims that follow.

1. A prepolymer or elastomer which is the reaction product of reactants (a) at least one polyester polyol or fatty acid derived polyol which is the reaction product of at least one initiator and a mixture of fatty acids or derivatives of fatty acids comprising at least about 45 weight percent monounsaturated fatty acids or derivatives thereof, (b) optionally, at least one polyol which is different from the polyol of (a); and (c) at least one isocyanate compound having an average of at least about 1.8 isocyanate groups per molecule.

2. A process comprising admixing reactants (a) at least one polyol composition comprising the fatty acid derived polyol which is the reaction product of at least one initiator and a mixture of fatty acids or derivatives of fatty acids comprising at least about any of 45 weight percent monounsaturated fatty acids or derivatives thereof; and (b) at least one isocyanate having an average functionality of at least about 1.8 under reaction conditions to form a reaction product which is an elastomer or prepolymer is formed therefrom.

3. The prepolymer or elastomer of claim 1 wherein the initiator is at least one polyol, hydroxylamine or polyamine initiator compound or combination thereof having an average of at least about 1.7 and at most about any of 4.0 hydroxyl, primary amine and/or secondary amine groups/molecule.

4. The prepolymer or elastomer of claim 1 wherein (b) at least one polyol different from the polyol of (a) comprises at least one polyether, polyester, polyacrylic, polycarbonate or combination thereof.

5. The prepolymer of claim 1 wherein the polyol or combination of polyols and the at least one isocyanate compound are reacted at a stoichiometric ratio of isocyanate groups to hydroxyl groups between 1.05:1 and 10:1.

6. The elastomer of claim 1 wherein there is an additional reactant (d) at least one chain extender selected from the group consisting of monomeric diols having from 2 to 20 carbon atoms and amines having from 2 to 20 carbon atoms.

7. The elastomer or prepolymer of claim 1 wherein unsaturation in the fatty acid is converted to hydroxyl groups.

8. The elastomer or prepolymer of claim 1 wherein the fatty acid derived polyol advantageously has an average number of functional groups reactive with aromatic isocyanate groups of at least about 1.7 and at most about any of 3.5.

9. The elastomer or prepolymer of claim 1 wherein the mixture of fatty acids or derivatives of fatty acids comprises at least about 65 weight percent monounsaturated fatty acids or derivatives thereof.

10. The elastomer or prepolymer of claim 1 wherein the fatty acid derived polyol has an number average molecular weight of at least about 1000 and at most about 10000.

11. The elastomer or prepolymer of claim 1 wherein at least one resulting hydroxymethyl-containing polyester polyol is a mixture of compounds having the following average structure (Structure 1):
[H—X](n−p)-R—[X—Z]p (I)
wherein R is the residue of an initiator compound having n hydroxyl and/or primary or secondary amine groups, where n is at least two; each X is independently —O—, —NH— or —NR′— in which R′ is an inertly substituted alkyl, aryl, cycloalkyl, or aralkyl group, p is a number from 1 to preferably about 16 representing the average number of [X—Z] groups per hydroxymethyl-containing polyester polyol molecule, Z is a linear or branched chain comprising residues of fatty acids wherein in at least one compound of Structure 1, Z corresponds to the following Structure 2: 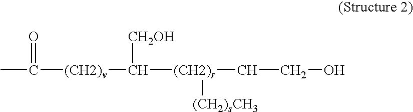
where v, r and s are integers and v is greater than 3, r is greater than or equal to zero, s is greater than or equal to zero, and v+r+s is from 10 to 18.

12. The elastomer or prepolymer of claim 1 wherein less than about 0.5 pphp of water is used.

13. The elastomer of claim 1 which has a Tg of less than about −20° C.

14. The elastomer of claim 1 which has at least two of the following properties:
(a) a tensile strength measured in accordance with ASTM D412 of at least about 1400 kPa;
(b) an elongation measured in accordance with ASTM D412 of at least about 100 percent;
(c) a Tg as determined by tan delta peak via dynamic mechanical analysis (DMA) tests using an instrument comparable to the instrument commercially available from TA Instruments under the trade designation RSA III using a rectangular geometry in tension according to manufacturer's directions and ramped from an initial temperature of −90° C. to a final temperature of 250° C. at 2° C./minute of preferably at most about −20;
(d) if thermoplastic, a Tm of at least about 80° C.; or
(e) a toughness defined as the total energy required to break the polymer specimen measured via integration of the stress versus strain curve in accordance with ASTM D412 of at least about 700 kPa.

15. An article comprising the elastomer of claim 1 or formed from the prepolymer of claim 1.

16. The article of claim 15 in the form of at least one molded object, thermoplastic polyurethane, foam (open or closed cell or a combination thereof), fiber, film, sheet, tube, roll, roller, gear, microcellular elastomer, shoe sole, a shoe insole, a vibration or wave energy absorbing material, flexible mechanical coupling, drive wheel; mallet or hammer head; roller for printing, roller for conveying; shock absorbent pad or bumper; tire, caster wheel, belting or coating thereon, furnishing, carpet backing, seating, cushioning, adhesive, sealant, coating, potting material, casting material, dispersion, mechanically frothed foam, carpet backing, foam gasket, foam insert, mat, or combination thereof.

17. A coating, adhesive or binding composition comprising the elastomer or prepolymer of claim 1.

18. A thermoplastic polyurethane comprising an elastomer or prepared from a prepolymer of claim 1 or comprising an elastomer.

19. An elastomer comprising a reaction product of reactants (a) at least one polyester polyol or fatty acid derived polyol which is the reaction product of at least one initiator and a mixture of fatty acids or derivatives of fatty acids comprising at least about 90 weight percent monounsaturated fatty acids or derivatives thereof, (b) optionally, at least one polyol which is different from the polyol of (a); (c) at least one isocyanate compound having an average of at least about 1.8 isocyanate groups per molecule; (d) at least one chain extender.

20. The elastomer of claim 19, wherein the initiator is hydrophobic and the at least one polyester polyol or fatty acid derived polyol has an equivalent molecular weight of less than about 750.

21. The elastomer of claim 19, wherein the initiator comprises at least one of 1,6-hexanediol, 1,4-dimethylolcyclo-hexane, a mixture of (cis, trans)-1,3-cyclohexanedimethanol and (cis,trans)-1,4-cyclohexanedimethanol, and 1,4 butanediol.

22. The elastomer of claim 19, wherein the initiator is poly(ethylene oxide) glycol with molecular weight higher than 400 and the at least one polyester polyol or fatty acid derived polyol has an equivalent molecular weight between 500 and 1200.

23. The elastomer of claim 19, wherein the initiator is hydrophobic, the at least one polyester polyol or fatty acid derived polyol has an equivalent molecular weight of at least than about 900, and the at least one chain extender is at least one of 2′,2-dihydroxy isopropyl-N aniline and 2-ethyl-1,3,-hexanediol.
